(19) United States
(12) Patent Application Publication
(10) Pub. No.: US 2026/0340914 A1
(43) Pub. Date: Oct. 29, 2026

(54) METHOD FOR GENERATING A MULTIDIMENSIONAL XCT MEASUREMENT DATA SET OF A SAMPLE, COMPUTER-IMPLEMENTED METHOD FOR RECONSTRUCTING A MULTIDIMENSIONAL STRUCTURE OF A SAMPLE FROM A MULTIDIMENSIONAL XCT MEASUREMENT DATA SET, AND DEVICE FOR OBTAINING A MULTIDIMENSIONAL XCT MEASUREMENT DATA SET

(71) Applicant: Friedrich-Schiller-Universitaet Jena, Jena (DE)

(72) Inventor: Martin WUENSCHE, Jena (DE)

(73) Assignee: Friedrich-Schiller-Universitaet Jena, Jena (DE)

(21) Appl. No.: 19/715,626

(22) Filed: Jun. 22, 2026

Related U.S. Application Data
(63) Continuation of application No. PCT/EP2024/087952, filed on Dec. 20, 2024.

(30) Foreign Application Priority Data
Dec. 22, 2023 (DE) 10 2023 136 484.7

(51) Int. Cl. G06T 12/20

(52) U.S. Cl. CPC G06T 12/20; G06T 2211/456

(57) ABSTRACT

There are disclosed a method and a device for generating a multidimensional XCT measurement data set of a sample using spectrally multi-structured scattering imaging, as well as computer-implemented methods for reconstructing a multidimensional structure of a sample from a multidimensional XCT measurement data set.

### CROSS-REFERENCE TO RELATED APPLICATIONS

This application is a continuation under 35 U.S.C. § 120 from International Application PCT/EP2024/087952, filed Dec. 20, 2024, which claims priority from DE Application 102023136484.7 filed Dec. 22, 2023, the contents of each of which are incorporated by reference herein.

### FIELD OF THE DISCLOSURE

The present invention relates to a method for generating a multidimensional (in particular three- or two-dimensional) EUV coherence tomography measurement data set of a sample by means of multispectral, in particular spectrally multi-structured, scattering imaging, a computer-implemented method for reconstructing a multidimensional structure from a multidimensional EUV coherence tomography measurement data set, and a device for obtaining multidimensional EUV coherence tomography measurement data of a sample.

### BACKGROUND

The so-called XCT-optical coherence tomography (coherence tomography) in the spectral range of the EUV radiation or X-ray (X-ray) radiation-is based, like optical coherence tomography in the visible spectral range (OCT), on backscattering of incident electromagnetic radiation at an interface of a sample to be examined. By evaluating the interference of the radiation (back)scattered at a plurality of interfaces, information about the sample to be examined can be obtained. A prerequisite for this is, in addition to the spatial superposition, a low temporal coherence of the superposed radiation. For a fundamental introduction into OCT technology, see e.g.: “Optical coherence tomography—principles and applications”, A F. Fercher et al., Rep. Prog. Phys. 66 239(2003) or “Optical Coherence Tomography”, W. Drexler et al., 2nd edition. Springer (2015), ISBN 978-3-319-06419-2 (eBook), ISBN 978-3-319-06418-5 (Hardcover), http://dx.doi.org/10.1007/978-3-319-06419-2.

XCT implements the concepts of OCT investigations for radiation in the UV range from 5 eV to 25 eV (respectively 50 nm to 250 nm) or EUV (extreme ultraviolet) range from 5 eV to 250 eV (respectively 5 nm to 250 nm) and in the (soft) X-ray range from 250 eV to >1000 eV (respectively 1.23 nm to 5 nm). Deviating from the generally common use of the abbreviation EUV for the aforementioned (energy/wavelength) range, the designation EUV for the common spectral range of UV (ultraviolet) and EUV is used herein for reasons of clarity (unless otherwise apparent). XCT uses, e.g., synchrotron-based or laser-based radiation sources for generating the EUV or X-ray radiation. XCT measures spectrally resolved broadband, e.g., EUV radiation which is reflected by an irradiated region of a sample, and determines a depth structure of the sample, averaged over the irradiated region, by means of Fourier transformation. See, for example, U.S. Pat. No. 7,656,538 B2 (“short-wave-length coherence tomography”) for laser-based XCT. Due to the large usable frequency bandwidths in, e.g., EUV, XCT enables an axial resolution in the range of, e.g., a few tens of nanometers, wherein newer developments aim for an axial resolution in the nanometer range. The high axial resolution, as it can be achieved, for example, in laser-based XCT, is accompanied by a-in comparison substantially coarser-lateral resolution in the range of a few 10 μm.

In the case of XCT, the lateral resolution of a sample is subject to inter alia the extent of the irradiated region, the irradiation direction, the irradiation distribution and the detector-side imaging. For a two-dimensional XCT analysis of a sample, the sample can be scanned laterally, usually by moving the sample relative to the incident radiation.

For the broadband EUV or X-ray radiation used, optical units with a low numerical aperture NA are usually used. This low NA determines the extent of the irradiated region and limits the lateral resolution. However, owing to the broadband nature of the radiation used and the low dispersion as well as the low refractive index of various materials in the underlying wavelength range combined with an often high absorption—it is difficult to implement a high NA in the optical setup.

To avoid undesired absorption, reflective optical units are used almost exclusively in the EUV wavelength range. This applies, on the one hand, to the irradiation of the broadband EUV radiation and also to the detection of the backscattered radiation.

In the scientific publication “Laboratory setup for extreme ultraviolet coherence tomography driven by a high-harmonic source”, J. Nathanael et al., Rev. Sci. Instrum. 90, 113702(2019), there are described an exemplary setup for the detection of XCT spectra using the example of a nanostructured sample as well as an exemplary data processing of the XCT spectra. The spectroscopic XCT is further explained in “Coherence tomography with broad bandwidth extreme ultraviolet and soft X-ray radiation”, S. Skruszewicz et al., Applied Physics B (2021) 127:55.

How an exemplary XCT evaluation in combination with a one-dimensional phase reconstruction algorithm (“one dimensional phase retrieval (PR) algorithm”) can derive the depth structure of a sample from an autocorrelation signal is explained in detail in the scientific publication “Optical coherence tomography with nanoscale axial resolution using a laser-driven high-harmonic source”, S. Fuchs et al., Vol. 4, No. 8/August 2017/Optica and the associated addition (“supplementary information”).

The increasing importance of structural investigations of complex 3D semiconductor structures with X-ray radiation is shown, for example, by the scientific publication “Soft x-ray: novel metrology for 3D profilometry and device pitch overlay”, C. Porter et al., Proc. of SPIE Vol. 12496 124961I-9, SPIE Advanced Lithography+Patterning, 2023, San Jose, California, United States using the example of “gate all around (GAA) devices”.

Further known are lensless imaging methods or coherent diffraction imaging methods, which are typically referred to as “coherent diffraction imaging” (CDI) or as ptychography (see inter alia in Rodenburg, “Ptychography and Related Diffractive Imaging Methods”, Advances in Imaging and Electron Physics 150 (2008)). These methods enable a high lateral resolution using spatially coherent radiation and large-area detectors or line detectors. In lensless imaging, a diffraction image of the sample is acquired with the detector, wherein imaging optical units can be dispensed with.

From the intensity data of these diffraction images, the phase of the detected light is calculated algorithmically in an iterative calculation in order to derive lateral sample information.

Exemplary iterative algorithms of CDI are known, for example, from Marchesini, “Invited Article: A unified evaluation of iterative projection algorithms for phase retrieval”, Rev. Sci. Instrum. 78, 011301(2007).

### SUMMARY

One aspect of this disclosure is based on the objective to specify methods that can detect and resolve nanostructures of a sample multidimensionally (for example, three-or two-dimensionally) within the scope of an EUV or X-ray radiation-based examination. Thereby, in particular comparable resolutions in the depth direction and the lateral directions are of interest. A further objective is to specify a device and a method with which data for a multidimensional structure analysis of a sample can be obtained. A further objective is to provide methods for evaluating such data.

At least one of these objectives is achieved by a method according to claim 1, a computer-implemented method according to claim 13, and a device according to claim 21. Further developments are specified in the dependent claims.

In one aspect, a method for generating a multidimensional XCT measurement data set [symbol] (Kx, Ky, Kz) of a sample using spectrally multi-structured scattering imaging comprises the following steps:
providing EUV/X-ray radiation with a broadband spectrum in the EUV to X-ray spectral range;
generating a plurality of scattering images, wherein each of the plurality of scattering images is generated using a measurement process that comprises the steps:
a) structuring the broadband spectrum of the EUV/X-ray radiation as a structured frequency range for providing an EUV/X-ray measurement beam with a measurement beam spectrum, which comprises at least one of a plurality of narrowband-structured frequency ranges, wherein at least one axial frequency space coordinate in the frequency space is assigned to each of the narrowband-structured frequency ranges;
b) irradiating the EUV/X-ray measurement beam onto a spatially laterally extended surface section of the sample;
c) acquiring scattered radiation, which is back-scattered by the sample, using a detector that outputs intensity values for the structured frequency range associated with the measurement process, to which intensity values at least one lateral frequency space coordinate in the frequency space is assigned, respectively, wherein the intensity values form the scattering image for the associated measurement process; and
combining the intensity values to form the multidimensional XCT measurement data set [symbol] (Kx, Ky, Kz), wherein the positions of the intensity values in the frequency space are given by at least a lateral frequency space coordinate and an axial frequency space coordinate.

In a further aspect, a device for obtaining a multidimensional XCT measurement data set [symbol] (Kx, Ky, Kz) of a sample comprises an EUV/X-ray radiation source for generating broadband EUV/X-ray radiation and an optical device for structuring the broadband spectrum of the EUV/X-ray radiation as a structured frequency range and for outputting an EUV/X-ray measurement beam with a measurement beam spectrum, which comprises at least one of a plurality of narrowband-structured frequency ranges for a measurement process, wherein at least one axial frequency space coordinate in the frequency space is assigned to the narrowband-structured frequency ranges. Furthermore, the device comprises a sample holder for supporting the sample at an angle of incidence of the EUV/X-ray measurement beam onto a surface section of the sample and a focusing element, which is configured to form a spatially lateral beam extension parameter of the EUV/X-ray measurement beam on the surface section of the sample, wherein the beam extension parameter is in particular in a range from one micrometer to several hundred micrometers, measured based on the FWHM intensity of the EUV/X-ray measurement beam. Furthermore, the device comprises a detector, which is arranged to record intensity values in a far field with respect to the sample, and a control device, which is connected to the optical device for structuring the broadband spectrum for setting the structured frequency range for a plurality of measurement processes and to the detector for reading out the intensity values and which is configured to compose the multidimensional XCT measurement data set [symbol] (Kx, Ky, Kz) from the intensity values.

In a further aspect, a computer-implemented method for reconstructing a multidimensional structure of a sample from a multidimensional XCT measurement data set [symbol] (Kx, Ky, Kz) comprises the steps:
reading in, into a processor, intensity values of a multidimensional XCT measurement data set [symbol] (Kx, Ky, Kz), wherein positions of the intensity values in the frequency space are given by at least one lateral frequency space coordinate and an axial frequency space coordinate, and
executing, with the processor, a Fourier transformation algorithm, which transforms the multidimensional XCT measurement data set [symbol] (Kx, Ky, Kz) into a sample structure data set [symbol] (x, y, z), wherein the sample structure data set O(x, y, z) comprises, in a physical space, a depth direction coordinate of the sample P, which is assigned to the axial frequency space coordinate, and at least one lateral coordinate of the sample, which is assigned to the at least one lateral frequency space coordinate.

In some further developments, the broadband spectrum can be structured by a monochromator diffracting a narrowband frequency range out of the EUV/X-ray radiation, the narrowband frequency range propagating as the EUV/X-ray measurement beam along an optical beam path to the sample.

In some developments, the scattered radiation can be acquired by detecting the scattered radiation of an associated structured frequency range, which is reflected by the sample, in a lateral dimension using a line detector or in two lateral dimensions using a two-dimensional detector, and outputting it as a one-dimensional or two-dimensional scattering image.

In some further developments, the at least one lateral frequency space coordinate can be specified by parameters of the EUV/X-ray measurement beam and parameters of the measurement process. Additionally or alternatively, the axial frequency space coordinate can be given by the photon energy of the radiation acquired at a lateral frequency space coordinate.

In some further developments, the intensity values of a scattering image of a measurement process can be projected onto an axial frequency space coordinate assigned to the measurement process, in particular onto an average axial frequency space coordinate assigned to the respective measurement process. This can be given, for example, by: Kz=(2 sin α) k; wherein k is a wave vector assigned to a narrowband-structured frequency range, and α is an angle of incidence of the EUV/X-ray measurement beam to the surface section of the sample.

In some further developments, each of the intensity values of a scattering image of a measurement process can be projected onto an axial frequency space coordinate of a plurality of axial frequency space coordinates, in particular in dependence on the at least one lateral frequency space coordinate of each of the intensity values. Additionally or alternatively, based on projected axial frequency space coordinates, axially uniform scattering images can be composed that comprise intensity values from scattering images acquired in different measurement processes at a same axial frequency space coordinate.

In some further developments, a plurality of axial frequency space coordinates can be assigned to the associated structured frequency range for at least one measurement process, and in a measurement process, intensity values for a plurality of scattering images can be obtained by assigning the intensity values to respectively associated axial frequency space coordinates of a narrowband-structured frequency range.

In some further developments, a first subgroup of measurement processes can be carried out at a first relative position between the incident EUV/X-ray measurement beam and the spatially laterally extended surface section of the sample and a second subgroup of measurement processes can be carried out at a second relative position between the incident EUV/X-ray measurement beam and the spatially laterally extended surface section of the sample, and furthermore, the multidimensional XCT measurement data set [symbol] (Kx, Ky, Kz) can be formed from the intensity values of the first subgroup and the second subgroup in the frequency space, in particular taking into account the axial frequency space coordinates.

In some further developments, the EUV/X-ray measurement beam can be irradiated onto a plurality of spatially laterally extended surface sections of the sample that adjoin one another or partially overlap one another, and the acquired intensity values of the scattering images assigned to the surface sections can be combined to form together the three-dimensional XCT measurement data set [symbol] (Kx, Ky, Kz).

In some further developments, the scattering images can be detected in a plurality of measurement processes with different structured frequency ranges. The plurality of scattering images can be acquired accordingly for a plurality of narrowband-structured frequency ranges, in particular for a plurality of central wavelengths.

In some further developments, the EUV/X-ray measurement beam can be spectrally structured for N measurement processes in different ways, in particular can be set for several narrowband-structured frequency ranges, in order to carry out N differently spectrally resolved measurement processes.

In some further developments, the EUV the plurality of scattering images can form combined as a two-dimensional Fourier measurement data set or as a three-dimensional Fourier measurement data set the multidimensional XCT measurement data set.

In some further developments of the computer-implemented method, the latter can further comprise:
a scaling step, in which for each of the plurality of axial frequency space coordinates of the frequency space, intensity values in the at least one lateral frequency coordinate are scaled based on a common photon energy, so that in particular the increments in the at least one lateral frequency coordinate, which underly the multidimensional XCT measurement data set [symbol] (Kx, Ky, Kz), are adapted to one another for all axial frequency space coordinates; and/or
a field calculation step, in which the square root of each intensity value is taken.

In some further developments of the computer-implemented method, the Fourier transformation algorithm can be configured to determine a phase of the detected scattered light by means of Fourier transformations, wherein in particular the phase is reconstructed iteratively by repeatedly executing a loop with at least one Fourier transformation, at least one inverse Fourier transformation, and setting boundary conditions in the Fourier or physical space for the Fourier transformation and/or the inverse Fourier transformation.

In some further developments of the computer-implemented method, the Fourier transformation algorithm can comprise:
an XCT reconstruction step for one-dimensional phase reconstruction in a depth direction coordinate of the physical space, which derives, based on the axial frequency space coordinate for lateral positions, a partially reconstructed sample structure O′(Kx′, Ky′, z), which comprises a plurality of depth-resolved diffractograms, wherein the XCT reconstruction step in particular comprises a 1D phase reconstruction XCT algorithm; and
a lateral reconstruction step for one-or two-dimensional phase reconstruction in at least one lateral coordinate, which derives the sample structure data set [symbol] (x, y, z) based on the at least one lateral frequency space coordinate and at least one subgroup of the plurality of depth-resolved diffractograms.

In some further developments of the computer-implemented method, the latter can further comprise
a signal evaluation step, in which accumulated signal contributions of the depth-resolved diffractograms are calculated in order to identify depth positions contributing to the sample structure data set O(x, y, z); and
wherein the subgroup of the plurality of depth-resolved diffractograms for the lateral reconstruction step can comprise the depth-resolved diffractograms of the contributing depth positions.

In some further developments of the computer-implemented method, the Fourier transformation algorithm can comprise a 3D reconstruction step for multidimensional phase reconstruction in a depth direction coordinate of the sample structure data set O(x, y, z) and at least one lateral coordinate of the sample structure data set O(x, y, z) based on the axial frequency space coordinate and the at least one lateral frequency space coordinate. In particular, a region of direct reflection can be excluded from the common reconstruction.

In some further developments of the computer-implemented method, the multidimensional XCT measurement data set O(Kx, Ky, Kz) can be generated according to one of the methods disclosed herein.

In some further developments of the computer-implemented method, a plurality of scattering images can be fed combined as a two-dimensional Fourier measurement data set or as a three-dimensional Fourier measurement data set to the computer-implemented method, wherein the scattering images were detected in a plurality of measurement processes with different structured frequency ranges.

In some further developments of the device, the EUV/X-ray radiation source can be a synchrotron-based or laser-based radiation source. Additionally or alternatively, the sample holder can be configured:
for supporting the sample for adjusting the angle of incidence of the EUV/X-ray measurement beam; and/or
for supporting the sample in the focus or in front of the focus of the focusing element; and/or
for scanning the sample by laterally moving the sample with respect to the EUV/X-ray measurement beam.

In some further developments of the device, the optical device can be configured as, in particular grating-based, grating pair-based or multi slit-based, mono-or multi-chromator. In particular, a grating-based or grating pair-based mono- or multi-chromator can be rotatably supported for adjusting a central frequency of the structured frequency range—additionally or alternatively, a multi slit-based mono- or multi-chromator can be adjustable for adjusting a central frequency of the structured frequency range with respect to a multi slit configuration, such as slit width.

Furthermore, additionally or alternatively, the focusing element can be arranged upstream or downstream of the optical device for structuring the broadband spectrum.

In some further developments of the device, the focusing element can be configured to form a spatially lateral beam extension parameter of the EUV/X-ray measurement beam on a surface section of the sample, which defines a lateral dimension of the sample and correspondingly a lateral frequency component and is in particular in a range from 1 μm to 1 mm, in particular from 10 μm to 500 μm, measured based on the FWHM intensity of the EUV/X-ray measurement beam.

In some further developments of the device, the detector can be configured to record one-dimensional scattering images as a line detector for acquiring a series of intensity values or to record two-dimensional scattering images as a two-dimensional detector for acquiring an array of intensity values, and/or can be rotatably supported for aligning an acquired lateral dimension. Furthermore, the intensity values of a measurement process acquired by the detector can each form a scattering image or an intensity value acquired by the detector can be assigned to one of a plurality of scattering images in dependence on an axial frequency space coordinate assigned to the intensity value.

In some further developments of the device, the control device can comprise a processor, which is configured to execute at least one of the methods disclosed herein.

In some further developments, radiation in the range from 5 eV to 250 eV and/or soft X-ray radiation in the range from 250 eV to 1000 eV can be provided as (spatially coherent) EUV/X-ray radiation. In particular, EUV radiation with a bandwidth in the range from 25 eV to 100 eV and/or soft X-ray radiation with a bandwidth in the range from 50 eV to 150 eV can be provided, wherein the bandwidths are in particular selected such that a number of axial frequency space coordinates required for the resolution in the depth direction, and, thus, of narrowband-structured frequency ranges, can be scanned in the measurement processes.

In some further developments, a spatially laterally extended surface section of the sample can extend in at least one direction laterally over one or a few micrometers up to several hundred micrometers, measured based on the FWHM (full width at half maximum) intensity of the EUV/X-ray measurement beam 12.

In some further developments, a one-dimensional scattering image can be acquired using the detector, which is in particular configured as a line detector or as a linearly movable detector, in which the intensity values are arranged in a row along a lateral frequency space coordinate (e.g., Kx or Ky). Accordingly, a two-dimensional XCT measurement data set with a lateral frequency space coordinate (Kx or Ky) and the axial frequency space coordinate (Kz) can be generated as a multidimensional XCT measurement data set [symbol] (Kx or Ky, Kz). If a plurality of Kz values is to be acquired per measurement process due to the measurement geometry or the measurement beam spectrum, a reassignment is possible for obtaining one-dimensional scattering images or generally the two-dimensional XCT measurement data set. In some further developments, a two-dimensional scattering image can be acquired using the detector, which is in particular configured as an area detector or as a detector movable on a two-dimensional position grid, in which the intensity values are arranged in a grid given by two lateral frequency space coordinates Kx and Ky. A three-dimensional XCT measurement data set with the two lateral frequency space coordinates Kx and Ky and the axial frequency space coordinate Kz can be generated as a multidimensional XCT measurement data set [symbol] (Kx, Ky, Kz). If a plurality of Kz values is to be acquired per measurement process due to the measurement geometry or the measurement beam spectrum, a reassignment is possible for obtaining two-dimensional scattering images or generally the three-dimensional XCT measurement data set.

In some further developments of the device, the optical device can be configured to set different structured frequency ranges, in particular a plurality of narrowband-structured frequency ranges, in particular with a plurality of central wavelengths, for a detection of the scattering images (19) in a plurality of measurement processes.

In further developments of the device, the device for obtaining a multidimensional XCT measurement data set can be configured to spectrally structure the EUV/X-ray measurement beam for N measurement processes differently, in particular to set it for several narrowband-structured frequency ranges, to perform N differently spectrally resolved measurement processes.

In some further developments of the method for generating a multidimensional XCT measurement data set or the computer-implemented method for reconstructing, the at least one lateral frequency space coordinate can be scaled depending on the axial frequency space coordinate when combining the intensity values to form the multidimensional XCT measurement data set.

Generally, a broadband spectrum in the UV/EUV to X-ray spectral range is understood herein to mean, for example, a spectrum that comprises a plurality of narrowband-structured frequency ranges and in particular enables selecting or outcoupling of several, e.g., 5 to 10, 10 to 100, or 10 to 1000 or more, narrowband-structured frequency ranges from the broadband spectrum. “Narrowband” refers here to that an axial frequency space coordinate in the frequency space can be assigned to the narrowband-structured frequency range—possibly in dependence on the lateral frequency space coordinate. Narrowband comprises, for example, spectral widths in the range of λ/δ λ (λ here as the center wavelength of the narrowband-structured frequency range and δ λ as the width, for example, the FWHM width, of the narrowband-structured frequency range): 5 (or 10 or 20 or 50) to 10,000 (or 5,000 or 2,000 or 1,000 or 500), in particular from 50 to 200, wherein the spectral width obviously also depends on the respective position of λ in the spectral range.

Furthermore, for example, broadband spectra of the provided EUV/X-ray radiation extend in the spectral range from 5 eV to >1000 eV, e.g., in the spectral range from 5 eV (or from 10 eV or 20 eV) to 1000 eV (or to 500 eV or 100 eV), in particular in the UV range from 5 eV to 25 eV (respectively 50 nm to 250 nm), in the UV/EUV (extreme ultraviolet) range from 5 eV to 250 eV (respectively 5 nm to 250 nm) and in the (soft) X-ray range from 250 eV to >1000 eV (respectively 1.23 nm to 5 nm) or within a spectral range associated with one or more of these ranges. Broadband comprises, for example, spectral widths in the range from 5 eV to 25 eV—in particular in the UV range—or spectral widths in the range from 5 eV (or from 10 eV or 25 eV or 30 eV) to 70 eV (or to 100 eV or 250 eV or 500 eV or 1,000 eV)—in particular in the EUV/X-ray range, and in particular spectral widths in the range from, for example, 30 eV to 100 eV in the UV/EUV/X-ray range.

The concepts described herein can comprise, inter alia, the following advantages in the structure analysis of a sample compared to prior art methods such as electron microscopy or avoid corresponding disadvantages of the prior art:

The invention enables a laterally extended depth structure imaging of multidimensional nanostructures in a spatially extended sample, such as, e.g., a nanometer layer coating of an optical element (e.g., lithography masks) or a nanostructured semiconductor element (e.g., microprocessors, memory elements). The laterally extended depth structure imaging proposed herein is performed with the aid of a novel concept in which XCT is combined with aspects of lensless imaging and which is referred to herein as diffractive XCT (DXCT for short) for “diffractive XUV or X-ray coherence tomography” (diffractive EUV/X-ray coherence tomography).

The inventors have recognized and been able to demonstrate that a combination of aspects of the XCT with aspects of coherent diffraction imaging can be implemented, wherein advantages of the high NA of the coherent diffraction imaging, in particular the increased lateral resolution, become accessible as part of a 2D or 3D nanoscopy. In other words, the proposed laterally extended depth structure imaging combines advantages of both methods and can, thus, starting from scattering images, simultaneously achieve a high axial resolution and a high lateral resolution in the multidimensional reconstruction of a depth structure of the sample. In connection with the concepts of the DXCT disclosed herein, “multidimensional” when generating a multidimensional XCT measurement data set and reconstructing a structure of a sample from a multidimensional XCT measurement data set means that, at the same time of an analysis of at least one lateral direction, an analysis in the axial direction is performed as well.

The inventors have recognized that, for the laterally extended depth structure imaging for sample reconstruction, neither the phase has to be known nor a complete sampling of the Fourier space is necessary. Although the measured, incompletely acquired Fourier space is associated with a lower resolution, this is acceptable for many structures in view of the large resolution potentials of the proposed laterally extended depth structure imaging in the multidimensional space, in particular as resolutions in the range of a few nanometers can be achieved.

The 2D or 3D depth structure imaging proposed herein can be applied to (large) samples for which the two- or three-dimensional Fourier space of the sample can be acquired to a sufficient extent as part of a DXCT measurement at many wavelengths using a correspondingly large detector. The size of the detector, i.e., the sampling/measurement signal acquisition in at least one lateral direction, is of importance for the information recording in this lateral direction and influences the lateral resolution. The spectral bandwidth or the property of the wavelength scan are of importance for the axial resolution.

The method proposed herein further shows advantages for samples, which, for example, due to their dimension, their weight and their shape, can only be aligned and moved in space with very high technical effort. Thus, the concepts disclosed herein can enable a high multidimensional resolution of the sample without the need for a controlled and precise rotation, as it is common in rotary or tomographic measurement methods such as computed tomography (CT).

Supplementarily, an additional rotation of the sample and/or of the illumination and measurement direction can also help in the concepts disclosed herein to further increase the spatial resolution by additional information of the two- or three-dimensional Fourier space of the sample.

The concepts proposed herein can already enable a high multidimensional resolution with detectors having a low NA. Supplementarily, with a high NA, a larger region in the multidimensional Fourier space of the sample can also be made accessible by technical measurement for the concepts disclosed herein, whereby the spatial resolution can be further increased.

For the inventive concepts disclosed herein for 2D or 3D imaging (“2D/3D nanoscopy”) having a resolution in the nanometer range in at least one lateral dimension and in the depth dimension (for example, in all three spatial dimensions), new applications open up such as the non-destructive examination of layer-like samples in reflection geometry (e.g., EUV mask metrology (layer-based photomasks in EUV lithography), of (multilayer) coatings such as, e.g., optical or EUV mirrors, of functional structures in solar cells or semiconductors (graphene-based electronics) and of biological membrane layer structures. Furthermore, they enable the diagnostics of periodic and non-periodic structures. In particular, the concepts disclosed herein for 2D or 3D imaging enable a two-/three-dimensional imaging of near-surface structures of thick samples. For example, in the examination of (structured) semiconductors, they represent an interesting alternative or supplement to scanning electron microscopy (SEM), to X-ray reflectometry (XRR), or to transmission electron microscopy (TEM), as the latter usually require a destructive or invasive preparation of the sample.

### BRIEF DESCRIPTION OF THE DRAWINGS

Concepts are disclosed herein that enable aspects from the prior art to be at least partially improved. In particular, further features and their usefulness result from the following description of embodiments on the basis of the figures. Of the figures:

FIG. 1 shows a schematic Kz-Kx section through an Ewald sphere to explain the measurement of the Fourier space in the context of a DXCT measurement method based on backscattering;

FIG. 2 shows a schematic representation of an exemplary DXCT measurement setup;

FIGS. 3A-3C show diagrams to illustrate an exemplary DXCT measurement method for obtaining photon energy-dependent scattering images;

FIG. 4 shows a diagram to illustrate the generation of a stack of scaled scattering images as a three-dimensional DXCT measurement data set;

FIG. 5 shows a flow diagram to illustrate an exemplary serial reconstruction of a three-dimensional structure of a sample from a three-dimensional DXCT measurement data set;

FIG. 6 shows an overview diagram for serial reconstruction;

FIG. 7 shows a flow diagram to illustrate an exemplary parallel reconstruction of a three-dimensional structure of a sample from a three-dimensional DXCT measurement data set;

FIG. 8 shows an overview diagram for parallel reconstruction; and

FIG. 9 shows a diagram to illustrate the extension of DXCT measurement data by lateral sampling of a sample.

### DETAILED DESCRIPTION

It is essential for at least some of the concepts described herein that, according to the invention, multidimensional and three-dimensional DXCT measurement data are obtained (for the first time) in the form of spectrally resolved scattering images (depending on the structure to be examined, also diffraction images) for a volume region of a sample and are combined for the evaluation.

Herein, the multidimensional DXCT measurement data generated and reconstructed according to the concepts disclosed herein comprise, in addition to an axial frequency space coordinate (Kz), at least one of the lateral frequency space coordinates (Kx, Ky). With new reconstruction methods proposed herein, a structure of the sample in 3D can be determined, e.g., from a stack of two-dimensional scattering images as part of a 3D phase reconstruction. In general, further new reconstruction strategies are proposed for a reconstruction of a 3D object/3D sample from the DXCT measurement data, in particular for obtaining two-dimensional or three-dimensional structure information having a high 2D or 3D resolution. The reconstruction strategies proposed herein differ in principle from the known reconstruction algorithms that are based on one-dimensional axial or two-dimensional lateral approaches. In addition to multidimensional DXCT measurement data, data of modeled 2D or 3D structures can be reconstructed with the new reconstruction strategy, for example, as part of a model matching.

The diffractive XCT proposed herein is a multispectral imaging method in which a set of recorded scattering images provides information about the sample along two frequency axes (Kx or Ky), Kz or along three frequency axes Kx, Ky, Kz. The scattering images are measured at different wavelengths in reflections and have no phase information. Diffractive XCT forms a specific (2D or 3D) Fourier space distribution of the sample from the scattering images. Starting from this distribution, the phase information can be derived along the (two or three) frequency axes and, thus, along the (two or three) spatial axes (here (x or y), z or x, y, z)—for a plurality of axes successively or simultaneously—using phase recovery algorithms. The spatial structure of the three-dimensional sample can, thus, be reconstructed.

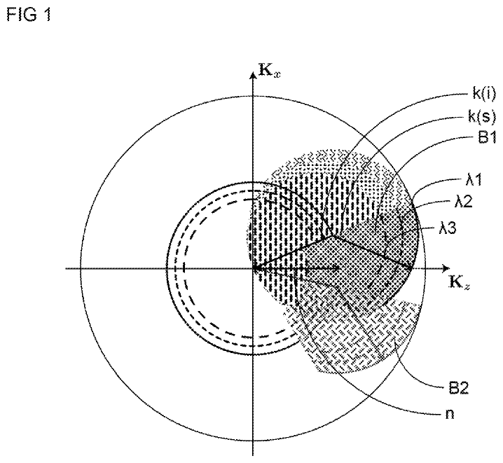

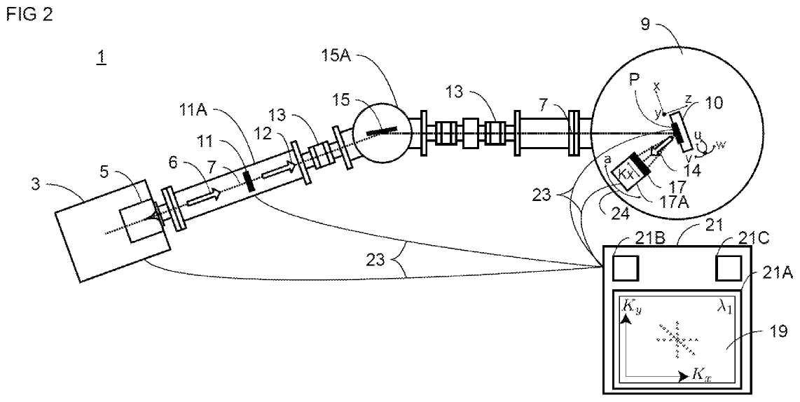

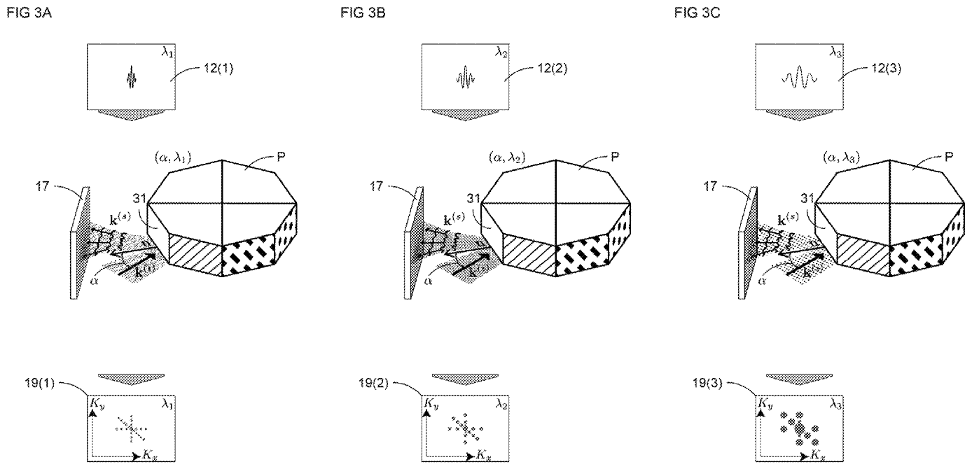

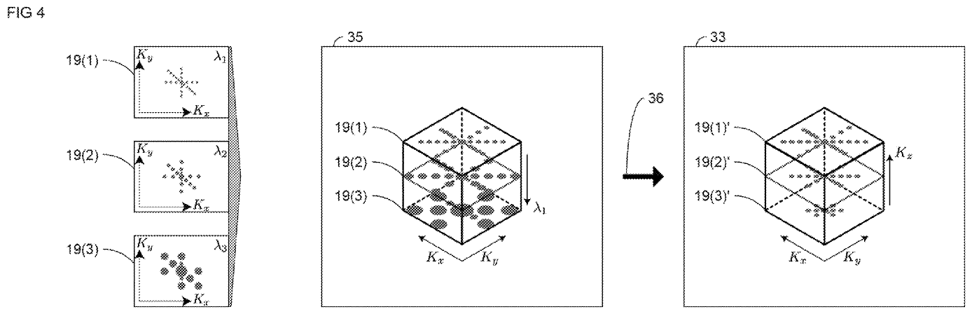

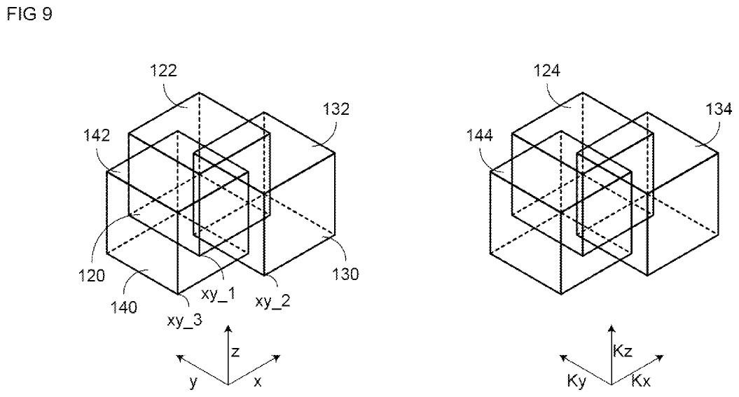

To explain the physical background of the diffractive XCT, the underlying backscattering is first considered generically (in 3D) (FIG. 1). Then, an exemplary DXCT measurement device (FIG. 2), exemplary DXCT measurement methods as well as the generation of a 3D Fourier data set [symbol] (Kx, Ky, Kz) (FIGS. 3 and 4) and exemplary evaluation methods (FIGS. 5-8) are described. Furthermore, a 2D implementation and a sampling in the context of DXCT (FIG. 9) are explained.

It is known that an electromagnetic field scattered at a sample corresponds in Fourier space in, for example, first Born's approximation to a 3D Fourier transformation of the spatial scattering potential of the sample. Conversely, given knowledge of the scattered field in Fourier space (given by the (detector pixel) values Kx, Ky, Kz as (spatial) frequency coordinates; accordingly, the Fourier space is also referred to herein as frequency space or K space), a spatial structure of the “scattering” sample can be reconstructed; i.e., the spatial structure can be calculated from the reflectively scanned Fourier space. A reconstruction is possible, for example, with the aid of Fourier transformations. The basis for the reconstruction strategies proposed herein is a measurement of DXCT measurement data in Fourier space. The measurement takes place, for example, with a pixelated (e.g., linear or planar) detector in backscattering.

FIG. 1 shows the backscattering of spatially coherent radiation with the aid of an Ewald sphere in the Kz-Kx section. FIG. 1 illustrates which region can be detected in Fourier space with diffractive XCT. A vector k(i) represents the incident radiation whose wavelength λ can be set in the context of the DXCT measurement and which specifies the illumination direction onto the sample. A normal vector n refers to the surface of the sample. A vector k(s) illustrates the backscattered radiation. Wherein the difference vector K=k(s)−k(i) and the change in k(i) give the sample information in Fourier space. The herein proposed measurement of the sample (DXCT measurement points) in the far field with a two-dimensional and pixelated detector gives access to the multidimensional Fourier space of the sample and, thus, to the (lateral) structure and the depth structure of the sample.

In the sectional representation shown in FIG. 1, DXCT measurement points in the 3D Fourier space correspond to measurement points with (spatial) frequency coordinates Kx, Kz. The frequency coordinate Kx and also the frequency coordinate Ky (not shown in FIG. 1) are given by the illumination geometry (parameters of the illuminating EUV/X-ray radiation, in particular of the measurement beam such as, e.g., beam parameters, spatial coherence, . . . ) and the measurement geometry (parameters of the measurement process such as angle of incidence, spatial distance, arrangement and geometry of the detector). The frequency coordinate Kz is given substantially by the photon energy or energy (“central” frequency Ω, wavelength λ or wave number k) of the acquired radiation. The following applies approximately:

Kz=(2ω cos α)/c=(4π cos α)/λ=(2 cos α)k,

wherein α is the angle of incidence through the illumination direction relative to the surface normal of the sample or the normal vector n. For the observation in relation to the surface of the sample, the cosine function would be replaced by a sine function. In other words, the intensity values of a scattering image of a measurement process can be projected onto an axial frequency space coordinate assigned to the measurement process, in particular onto an average axial frequency space coordinate assigned to the respective measurement process. The described relationship between Kz and wave number k applies, in particular, to measurements in which detectors are used that cover only a small solid angle portion of the backscattered field and/or if the Fourier space of the sample is relatively coarsely discretized.

For large detectors or for a more precise discretization of the Fourier space of the sample, the curvature of the Ewald sphere can be taken into account in the calculation of Kz. In other words, each of the intensity values of a scattering image of a measurement process can be projected onto an axial frequency space coordinate Kz of a plurality of axial frequency space coordinates, in particular in dependence on the at least one lateral frequency space coordinate of each of the intensity values. In particular, based on the projected axial frequency space coordinates Kz, axially uniform scattering images can be combined that comprise intensity values from scattering images acquired in different measurement processes for a same axial frequency space coordinate.

Furthermore, for at least one measurement process, for example, two narrowband frequency ranges, which are spectrally distant from each other, and, thus, different axial frequency space coordinates can be assigned to the associated (narrowband) structured frequency range, so that in a measurement process, a plurality of scattering images can be obtained by assigning the intensity values of different pixels to different axial frequency space coordinates.

Three circle segments shown in dashed lines in FIG. 1 represent the DXCT measurement points in the Fourier space that can be detected with a detector for one of the wavelengths λ1, λ2, and λ3, respectively. It can be seen that both the position and the length of a circle segment, i.e., the DXCT measurement points in the Fourier space that can be detected for one wavelength, change when the measurements are carried out (in backscattering) with a changed (central) wavelength. The region in the Fourier space that can be detected by diffractive XCT results from the adjustable wavelength range and the spatial geometry of the measurement set-up. Exemplarily, a detectable region B1 of the Fourier space in the Kz-Kx section through the Ewald sphere is shown in FIG. 1.

In FIG. 1, an oversized NA of the detector is assumed schematically to illustrate the DXCT measurement. Such a large NA is usually not present in the DXCT measurement set-ups and methods described in the following. Thus, a (laser-based) diffractive XCT also functions, for example, with substantially smaller NA values.

For example, a detector angle acceptance of ±0.3° and an NA of ~0.006 were used in a series of measurements. In this case and for a single measurement with a single wavelength, measurement points (Kx, Ky) arranged in a substantially linear row result for a fixed Kz value. As already mentioned, these measurement points (Kx, Ky) can also address respectively different Kz values if, for example, larger solid angles or a larger NA and/or a finer spectral discretization or spectral resolution is/are present. For such cases, the individual measurement points (Kx, Ky) are to be assigned to the respectively associated Kz values in the 3D Fourier data set [symbol] (Kx, Ky, Kz).

For the laser-based DXCT set-up described in the following, the wavelength can be varied, for example, in the range from about 7 nm to 60 nm (respectively, 20 eV to 180 eV). The DXCT proposed herein can also be implemented with corresponding light sources and optical units, for example, for more long-wave spectral ranges >60 nm (<20 eV) and for more short-wave spectral ranges <7 nm (>180 eV). The so-called water window between 2.3 nm and 4.4 nm (282 eV −533 eV) has a particular relevance for organic samples.

If many measurements are carried out with central wave numbers k₀ in the range 0<k_{0,min}≤k₀≤k_{0,max}, the form of the detectable region B1 in the 3D Fourier space corresponds approximately to a truncated pyramid for an exemplary rectangular pixel array as a (planar) detector. The (non-measurable) tip of the pyramid lies in the coordinate origin of the Fourier space. The height of the pyramid is determined by the complete bandwidth of the wavelengths used and can be understood as a measure for the axial resolution. The opening angle of the truncated pyramid corresponds to an angle acceptance of the detector, i.e., the numerical aperture NA of the detector, and can be understood as a measure for the lateral resolution.

In the DXCT measurement method described in more detail in the following, scattering images of a sample are acquired for a plurality of central wavelengths (photon energies). As explained above, the photon energy-dependent scattering images can be assigned to the lateral frequency coordination Kx and Ky. For the reconstruction of the sample, the photon energy on which a scattering image is based is transferred according to the above projection to one or more Kz values of the energy-dependent frequency coordinate. A stack of scattering images can be combined as a two-dimensional Fourier measurement data set [symbol] ((Kx or Ky), Kz) or as a three-dimensional Fourier measurement data set [symbol] (Kx, Ky, Kz) and fed as a “measurement result” to an evaluation. For example, a three-dimensional Fourier measurement data set [symbol] (Kx, Ky, Kz) can be evaluated for the reconstruction of a three-dimensional sample structure O(x, y, z) in the physical space.

In tomographic measurement methods, the sample is measured from different illumination directions in order to ensure a high three-dimensional resolution. In the diffractive XCT disclosed herein, a single illumination direction is already sufficient to enable a high two-/three-dimensional resolution. Thus, lateral resolutions of <100 nm in combination with an axial resolution of a few 10 nm can be achieved with the DXCT.

Furthermore, for the case of diffractive XCT, the detectable region B1 in the Fourier space can be additionally expanded by applying also tomographic methods, such as by rotating the illumination direction of the sample and the detector. This is shown schematically in FIG. 1 for the case of a second detectable region B2 in the Fourier space with a changed illumination direction. Here, for illustration, the illumination direction is exemplarily rotated by −35°. In other words, after rotating the sample into a new alignment with respect to the usually fixed beam path and readjusting the detector, a further DXCT measurement can be carried out and, thus, a further region in the Fourier space can be filled with DXCT measurement points. In other words, a first subgroup of measurement processes can be carried out at a first relative position between the incident EUV/X-ray measurement beam and the spatially laterally extended surface section of the sample P and a second subgroup of measurement processes can be carried out at a second relative position between the incident EUV/X-ray measurement beam and the spatially laterally extended surface section of the sample P, so that the intensity values of the first subgroup and the second subgroup complement one another in the frequency space (in particular taking into account the axial frequency space coordinates). In the context of laser-based diffractive XCT, there can be implemented, e.g., changes in the angle of incidence of a few tenths of degrees, over a few degrees up to a full rotation, so that the detected regions in the Fourier space can, for example, partially overlap or adjoin one another. Thus, for expanding the Fourier space to be analyzed, the detector can optionally be set relative to the sample, e.g., using a controllable detector holder (see FIG. 2).

The explanations in connection with the 2D section of the Ewald sphere shown in FIG. 1 already show that the concepts disclosed herein for scattering analysis are likewise applicable to two-dimensional XCT measurement data, which comprise an axial frequency space coordinate Kz and a lateral frequency space coordinate. Such two-dimensional XCT measurement data can be detected, e.g., for a two-dimensionally structured sample using a line detector according to the concepts disclosed herein and the date can subsequently be used for reconstructing a two-dimensional structure of the sample.

The following description refers by way of example to the analysis of a sample in three dimensions, see in particular the description with reference to two-dimensional scattering images (Kx, Ky), as they are the basis for, e.g., FIGS. 3-8.

An exemplary setup of a laser-based DXCT measurement setup 1 configured for detecting DXCT measurement data is shown schematically in FIG. 2.

The exemplary DXCT measurement setup 1 comprises a (laser) radiation source 3. The radiation source 3 is based, e.g., on a femtosecond laser system for generating pulsed laser radiation with a central wavelength of, e.g., 800 nm and pulse durations in the range of a few tens of femtoseconds at repetition rates in the kHz range. The radiation source 3 furthermore comprises an optical parametric amplifier, which can shift the wavelength, e.g., into the infrared or into the region by 1300 nm and generate laser pulses with a pulse energy in the mJ range. The radiation source 3 furthermore comprises a source chamber 5. The laser pulses are focused into the source chamber 5, which is filled, e.g., with argon gas, for generating high harmonics (high harmonic generation HHG). In addition to a classical highly modulated HHG spectrum, a quasi-continuous spectrum, e.g., in the EUV range, can be generated by changing the signal wavelength in the optical parametric amplifier in temporal averaging. An EUV/X-ray radiation 6 generated in this way propagates along an optical beam path 7 within the DXCT measurement setup 1.

In addition to the DXCT measurement setup presented exemplarily, the DXCT method can likewise be carried out with other radiation sources or modified laser-based setups that can provide (spatially coherent) radiation for a plurality of wavelengths. Thus, for example, accelerator-based radiation sources such as a synchrotron- or plasma-based radiation sources as well as other laser radiation sources such as fiber lasers, disk lasers or rod lasers can be used.

For the process of generating high harmonics, OPCPA systems can furthermore be used instead of OPA for the wavelength adaptation of the fundamentals. Furthermore, so-called gating approaches can also be used for generating broadband EUV radiation by means of generating high harmonics, in order to limit the number of points in time of generating the high harmonics as far as possible. A common approach in this case is the use of laser pulses with a few optical cycles, wherein in the ideal case the high harmonics are emitted only at one point in time.

With powerful laser beam sources, coherent broadband radiation can be provided for the ultraviolet spectral range (UV, >5 eV or <250 nm), the extreme ultraviolet spectral range (EUV, >25 eV or <50 nm) and the soft X-ray range (SXR, >250 eV or <5 nm) using the generation of high harmonics. This comprises the spectral ranges with low absorption, such as the silicon transmission window in the EUV range (30-99 eV; 12-41 nm) for semiconductor-based samples and the water transmission window in the X-ray range (285-531 eV; 4.4-2.3 nm) for organic samples.

The maximum (theoretical) axial resolution is determined decisively by the coherence length l_{C}≈(2 ln 2)/π*(λ²/Δλ) and, thus, by the broadband nature of the light source used. In these spectral ranges, for example, axial resolutions of ~11 nm for the silicon transmission window and ~3 nm for the water transmission window are, thus, theoretically possible with the diffractive XCT. With the concepts of the DXCT disclosed herein, for example, lateral resolutions of ≤100 nm can be achieved with a single illumination geometry (i.e., without sample rotation). In general, spectral windows can be addressed depending on the sample material, the absorption present and the resolution.

In the DXCT, the relevant spectral range can be formed from (a plurality of narrowband) structured frequency ranges for a sufficient number of measurement processes (scattering images) with the measurement beam, for example, 50, 100, 200, 500 or more measurement processes, the central photon energies or wavelengths of which are respectively spaced apart from each other by, for example, 0.1 eV, 0.2 eV, 0.5 eV, 1 eV or more.

With respect to the coherence of the radiation, in particular the coherence in the lateral direction (spatial coherence) plays a role. This lateral coherence is preferably given via the measurement beam in such a way that a generation of scattering images of as high a contrast as possible is enabled for a lateral examination of the sample.

In general, and in particular in comparison with a synchrotron, laser-based radiation sources, which are based on the generation of high harmonics, have the advantage of a compact setup. Furthermore, laser-based radiation sources can ensure a high photon flux with a high spatial coherence. Furthermore, in the spectral range accessible to HHG, the reflectivities of solid-state samples can be sufficiently high, so that laser-based radiation sources can be used for the examination of, e.g., lithography masks and nanostructured solid-state samples of materials science, in particular with buried 2D materials. The sensitivity with which structures can be measured depends on factors such as the scattering cross-section, the size and the roughness of the structure. At least for the case of a layer-like structure in which a reflectivity can also be defined, structures with reflectivities in the range from about 0.001% up to 100% can be measured using DXCT.

Important for a good reconstructability of a 3D Fourier data set [symbol] (Kx, Ky, Kz) is, e.g., a good contrast of (different) diffraction or interference structures in the scattering images. Among other things, a high spatial coherence of the (e.g., EUV) radiation over the entire beam cross-section, as can be present for laser-based EUV sources, has a positive effect on the contrast in the scattering images.

Following the EUV/X-ray generation in the source chamber 5, the optical beam path 7 of the EUV/X-ray radiation runs in vacuum up to a sample chamber 9, in which a sample P is arranged in the beam path 7 using a sample holder 10. For the DXCT analysis of the sample P, e.g., a pressure in the range of 1*10⁻⁸ mbar can be achieved with the aid of differential pump stages in the sample chamber 9.

The EUV/X-ray radiation 6 generated in the source chamber 5 is spectrally structured using a unit (shown by way of example as a filter unit 11 in FIG. 2) structuring the spectrum (generally an optical device for structuring the broadband spectrum). The structuring unit can act on EUV/X-ray radiation with both a spectrally modulated HHG spectrum and with a quasi-continuous spectrum.

In the exemplary embodiment of FIG. 2, the filter unit 11 is arranged in a filter chamber 11A in the beam path 7 and spectrally forms an EUV/X-ray measurement beam 12 from the EUV/X-ray radiation 6. The EUV/X-ray measurement beam 12 comprises at least one, e.g., narrowband frequency component and/or a frequency component structured in another way. The frequency component is adjustable, e.g., in its central frequency in the frequency range of the entering EUV/X-ray radiation 6 and is adjusted in each case for a measurement process of the diffractive XCT, i.e., for the generation of a scattering image.

For example, the filter unit 11 is configured as a mono- or multi-chromator (e.g., grating-based, grating pair-based, multi slit-based) that is adjustable in the spectral transmission. A monochromator can spectrally limit the incident broadband EUV/X-ray radiation 6 and transmits, e.g., a narrowband frequency component with a spectral narrowband of up to ~10000 (λ/δ λ). Larger bandwidths can be realized without problems. The filter unit 11 is controllable with respect to the specific selection of the frequency component to be transmitted; thus, a grating-based monochromator can be adjusted, for example, by rotation in the central frequency of the transmitted structured frequency range. For example, for a coherent X-ray spectrum, the frequency component can be varied in, e.g., 1 eV-steps of 310-430 eV (2.9-4.0 nm) in the region of the water transmission window and, for a coherent EUV spectrum, the frequency component can be varied in, e.g., 0.1 eV-steps of 50-100 eV (25-50 nm) in the region of the silicon transmission window. A multi-chromator can spectrally limit the incident broadband EUV/X-ray radiation 6 to a plurality of spectral narrowband frequency components and transmits, e.g., each narrowband frequency component with a spectral narrowband of up to ~10000 (λ/δ λ) onto the sample to be examined.

Infrared radiation components can be present in the EUV/X-ray radiation 6 and in the EUV/X-ray measurement beam 12. In the exemplary embodiment of FIG. 2, these are filtered from the EUV/X-ray measurement beam 12 (or from the EUV/X-ray radiation 6) using one or more thin filter foils 13 or membranes consisting, inter alia, of aluminum or zirconium. Filter foils made of other materials can be provided for the respective underlying spectral window. The infrared radiation components can alternatively and/or supplementarily be filtered using spatial filter diaphragms and/or optimized multilayer mirrors.

FIG. 2 further shows a focusing chamber 15A which is arranged exemplarily downstream of the filter chamber 11A. Alternatively, the focusing chamber 15A can be arranged upstream of the filter chamber (i.e., in the beam path 7 in the region of the EUV/X-ray radiation 6). In the focusing chamber 15A, one (or more) mirrors (generally one (or more) focusing elements) for focusing the EUV/X-ray measurement beam 12 onto the sample P can be in the beam path 7; exemplary shapings of the mirror typically comprise paraboloids, ellipsoids, and toroids. In the focusing chamber 15A, for example, a background pressure of, e.g., about 5*10⁻⁷ mbar is present.

Generally, a focusing element can, thus, be arranged upstream or downstream of the optical device for structuring the broadband spectrum.

Exemplarily, the EUV/X-ray measurement beam 12 in the focusing chamber 15A is directed onto the sample P by a toroid mirror 15 in FIG. 2. An exemplary focal length is f=1 m with a grazing incidence of 10°. An exemplary numerical aperture (NA) of the toroid mirror can be in the range of, e.g., 0.01-0.1, for example, at 0.03. The focus diameter (FWHM)—as an example of a spatially lateral beam extension parameter of the EUV/X-ray beam—can typically be in the range from about 1 μm up to one millimeter or, e.g., in the range from about 10 μm to 500 μm, for example, at 10 μm or 100 μm. Thus, under measurement conditions, a surface section of the sample P of, for example, about 100 μm² to 10000 μm² is irradiated with the spectrally selected, spatially coherent radiation of the EUV/X-ray measurement beam 12. The spatially lateral beam extension parameter defines a lateral dimension and correspondingly a lateral frequency component.

Due to the position of the irradiated region of the sample being in the focus, the wavefront can be used with a constant k(i) as the basis for of the reconstruction. Alternatively, the position of the irradiated region of the sample can lie, e.g., in front of the focus, in order to enlarge the irradiated region laterally and to reduce the fluence. One can then speak of performing a DXCT at an out-of-focus position of the sample, which can be taken into account in the reconstruction.

Taking into account the generally low reflectivity in the EUV/X-ray range, the sample P is preferably irradiated at an oblique angle. For example, the angle of incidence α to the normal of the surface of the sample P can lie in the range of 5° to 45°, e.g., at 10° or 15°. The angle between incident EUV/X-ray measurement beam 12 and backscattered radiation (scattered radiation 14) is 2α and gives the geometric arrangement of a detection chamber 75A, in particular relative to the components forming the EUV/X-ray measurement beam 12. The angle of incidence α additionally has an effect on the maximum achievable axial resolution (in the depth direction) because the axial resolution with an oblique incidence is limited by the projection and an additional refraction upon entry into the sample P. The illumination of the sample P at an angle furthermore assists in the separation of the incident EUV radiation from the emerging scattered radiation 14.

The radiation of the EUV/X-ray measurement beam 12 penetrating two-dimensionally into the sample P is scattered at inner structures of the sample P, depending on the absorption in the material, near the surface, for example, up to depths of, e.g., a few micrometers. Depending on the absorption, in the context of diffractive XCT, a depth analysis can, thus, be performed for a near-surface volume portion of the sample P in the range of, e.g., (10×10×2)μm³ to (100×100×5) μm³.

For expanding the volume portion to be analyzed, the sample P and the beam path 7 can be set in their position relative to one another using a controllable sample holder (illustrated by the rotation vectors u, v, w indicated in FIG. 2 in the sample chamber 9). With regard to the DXCT analysis, the controllable sample holder can be configured to set an angle of incidence of the EUV/X-ray measurement beam 12 with respect to a normal of the surface section of the sample P in such a way that the same surface section is irradiated at a different angle of incidence α′. This enables measurements to be carried out under different reflection conditions, whereby the measurement data obtained and to be evaluated in the Fourier space can be expanded. (See the explanations for the regions B1 and B2 of the Fourier space in FIG. 1.)

Further, in some embodiments, the sample P can be moved in a (lateral) direction with respect to the beam path 7, e.g., orthogonally to the normal of the sample surface or orthogonally to the angle of incidence of the EUV/X-ray measurement beam (illustrated by the axes x, y, z of the sample indicated in FIG. 2 in the sample chamber 9). The EUV/X-ray measurement beam 12, thus, impinges on the surface of the sample P at different positions and enters the sample P. This enables DXCT measurements at adjacent, preferably overlapping, lateral regions of the sample P, whereby a large-area scanning of a sample is enabled. (See also FIG. 9 and associated description.)

The scattered radiation 14 reflected by the sample P is acquired using a two-dimensional detector 17. The detector 17, e.g., a CCD camera with 2048×2048 or 4096×4096 pixels, is arranged in the detection chamber 17A. The detector 17 is configured for the measurement of photons, e.g., in the energy range from about 1 eV to 30 keV, in particular in the EUV and/or X-ray range. E.g., an in-vacuum CCD camera MTE 2048B from Princeton Instruments with a large-area, back-illuminated sensor and a quantum efficiency greater than 95% can be used.

The detector 17 can, e.g., for a lateral extent of, e.g., 27.6 mm×27.6 mm, be arranged at a distance of, e.g., 100 mm from the sample P and, thus, detect a solid angle range of about 0.076 sr. The detector 17 is, for example, positioned in the far field of the beam geometry of the scattered radiation and, during the DXCT measurement, detects pixel-related intensity values of the incident scattered radiation 14. The intensity values are transmitted-for the respectively adjusted, narrowband-structured EUV/X-ray measurement beam 12—as a scattering image to an evaluation unit 21. A schematic exemplary scattering image 19 is shown in FIG. 2 on an input and output device 21A of the evaluation unit 21.

Further components of the DXCT measurement setup 1 can comprise components for beam inspection such as spectrometer modules, mirrors and focus diagnostics, which can be introduced into the beam path as required for, e.g., the alignment.

The detector 17 supplies two-dimensional (pixel-resolved) intensity values (pixel size, e.g., 13.5 μm×13.5 μm). The intensity values represent the lateral physical (spatial) frequency components Kx and Ky in the frequency space of the sample P. If the EUV/X-ray measurement beam 12, for example, within a selected spectral range or frequency range, is relatively coarsely restricted to a narrowband frequency range of the EUV/X-ray radiation 6 and/or a detector having a low NA is used, a specific energy component, the frequency coordinate Kz, can typically be assigned to the scattering image 19. Otherwise, pixel-specific frequency coordinates Kz, which result from the respective setup and the respective structured frequency range for a pixel in a measurement process, can be assigned to the scattering image 19. In the scattering image 19 indicated in FIG. 2, e.g., interferences due to the reflected signal of regions of the sample P lying at different depths, such as, e.g., a layer structure defined in the nanometer range, are present.

As explained in the following, a joint evaluation of a plurality of scattering images 19 can be carried out in the evaluation unit 21, wherein the scattering images 19 were detected in a plurality of measurement processes with different (narrowband) structured frequency ranges; in the example, an energy component and, thus, frequency coordinates Kz are assigned to each of the scattering images 19. A multidimensional characterization of the sample P can be derived from the scattering images 19—as explained in more detail in the following—and, for example, a layer structure of the sample can be analyzed.

In the evaluation of the acquired spectrum, the unavoidable absorption of the EUV radiation propagating in the sample P plays a significant role, specifically also in the EUV range. The strength of the absorption (and, thus, the transmission of the radiation to a deeper layer transition) depends on the frequency of the radiation and the materials present in a sample P and, thus, is to be taken into account in the evaluation.

The evaluation unit 21 can comprise a central processing unit (CPU or GPU) that is programmed to carry out calculations in connection with the adaptation of model data to DXCT measurement data by executing instructions stored in program code. The CPU can comprise a microprocessor 21B or a plurality of microprocessors in connection with a memory element 21C or a plurality of memory elements as well as the already mentioned input and output device 21A (e.g., a touchscreen or a screen). The memory element 21C can store one or more microprocessor-readable instructions (program code), DXCT measurement data and model data, and provide them to the microprocessor 21B for the data processing. For example, the microprocessor 21B can carry out a Fourier transformation of the DXCT measurement data (in particular iteratively determine the phase of the detected scattered light and, thus, the sample structure in the physical space), derive layers, layer thicknesses and layer transitions, in particular their lateral extents and their positions in the depth direction, extract spectrally resolved reflectivity coefficients, initialize and update model data, model spectrally resolved model reflectivity coefficients based on at least one parameter in a layer transition-specific manner and optimize model data on the basis of values determined for the parameters. In particular, the microprocessor 21B can be configured, for example, to carry out (complex value) Fourier transformations in 1D, 2D and/or 3D, in order to reconstruct the sample from stacks of scattering images 19. Furthermore, the evaluation unit 21 can comprise a control for controlling different components of the DXCT measurement setup 1, in order to carry out desired actions during the DXCT measurement, such as the adjustment of parameters of the EUV/X-ray radiation 6 or of the EUV/X-ray measurement beam 12, such as, in particular, a frequency structuring/filtering of the EUV/X-ray radiation 6, in particular the setting of spectrally structured (narrowband) frequency ranges for the respective scattering images 19, the size selection and position selection of an irradiated surface section, the exposure duration of the surface and the selection of the angle of incidence onto the sample P. Furthermore, the evaluation unit 21 can carry out the reading out of, access to and/or the transmission of measurement data sets of the detector 15 (intensity values of the scattering images) and the processing of the scattering images to form a scaled 3D measurement data set/scattering image set, etc. Exemplarily, control connections 23 are shown in FIG. 2 that connect the evaluation unit 21 and the radiation source 3, the filter chamber 11A, the detector 17, as well as the sample holder 10 for the exchange of control data.

For further details of an exemplary DXCT measurement setup 1, reference is made to the cited publications relating to XCT measurement setups, the teachings of which are applicable for a technical implementation of different aspects of a DXCT measurement setup 1. With regard to the newly introduced approach of the spectral structuring and the implementation of the scattering imaging, reference is made to the explanations given herein.

For the rotational expansion of the Fourier space to be analyzed, there can be rotation using a spatially adjustable sample holder (indicated in FIG. 2 by the rotation vectors u, v, w) as well as a spatially adjustable detector holder (indicated in FIG. 2 by the rotation vectors a).

FIGS. 3A-3C illustrate the DXCT measurement principle on three exemplary measurement processes that are performed with measurement beams 12(1), 12(2), 12(3). The measurement beams 12(1), 12(2), 12(3) are each limited to different narrowband-structured frequency ranges in the optical device 11 for structuring the broadband spectrum of the spatially coherent EUV/X-ray radiation 6. In this example, the spectral structure of the coherent radiation, the beam geometry and the detection geometry are selected such that the measurement beams 12(1), 12(2), 12(3) can respectively be assigned to an energy-dependent frequency coordinate Kz(1), Kz(2), Kz(3). In other implementations, the measurement beams 12(1), 12(2), 12(3) can respectively be assigned to a plurality of energy-dependent frequency coordinates Kz, which is to be taken into account in the calculation of the sample structure.

As illustrated in FIGS. 3A-3C, the measurement beams 12(1), 12(2), 12(3) can be a correspondingly spectrally narrow, pulsed laser radiation with different central wavelengths λ1, λ2, λ3, which are generated with the aid of HHG and an adjustable filter.

To generate associated scattering images 19(1), 19(2), 19(3), the measurement beams 12(1), 12(2), 12(3) are directed onto a surface section 31 of the schematically shown sample P. The irradiated surface section 31 of the sample P and the illumination direction (vector k(i), angle of incidence α with respect to normal vector n of the surface section 31) are—as shown in FIGS. 3A-3C—identical in all three measurement processes, only the structuring of the broadband, spatially coherent EUV/X-ray radiation 6 is respectively adapted to different central wavelengths λ1, λ2, λ3.

According to the DXCT measurement principle, scattering images of a sample P are acquired for a plurality of (narrowband) structured frequency ranges (wavelengths/photon energies). Thus, in FIGS. 3A-3C, corresponding photon energy-dependent intensity distributions of the backscattered scattered radiation (vector k(s)) are recorded in the far field using the detector 17 and are output as scattering images 19(1), 19(2), 19(3) for further processing. The scattering images 19(1), 19(2), 19(3) are an example of a two-dimensional arrangement of intensity values of the scattered radiation that are acquired using a detector in the far field. For the reconstruction of the sample, the photon energy of each scattering image can be transferred into the Fourier space, e.g., according to the aforementioned projection Kz=(2 cos α) k. As already mentioned, this simplified projection applies exemplarily to the case in which the curvature of the Ewald sphere is neglected for the detector surface. If such a simplified projection of a detected scattering image (“detector image”) onto a respective axial frequency space coordinate Kz is not possible, corresponding Kz values can specifically to Kx, Ky also be assigned to the acquired intensity values. From the intensity values acquired in the measurement processes (i.e., the originally acquired scattering images) and the assigned Kz values, Kz-adapted scattering images can be formed in which the intensity values are now respectively assigned to a Kz value (corresponding to the scattering images 19(1), 19(2), 19(3) of the simplified projection). It is noted that the assignment of Kz values can be implemented both as part of the generation of a multidimensional XCT measurement data set [symbol] (Kx, Ky, Kz) and as a preparatory step in the reconstruction of a multidimensional structure of the sample. Furthermore, the person skilled in the art will recognize that, alternatively, the processing based on the acquired intensity values can be performed taking into account pixel-specific axial frequency space coordinates Kz, i.e., without explicit formation of Kz-adapted scattering images, and can be implemented algorithmically.

To simplify the explanation of the reconstruction of a multidimensional structure of a sample (P) from a multidimensional XCT measurement data set, scattering images 19(1), 19(2), 19(3) with a specifically assigned axial frequency space coordinate Kz are subsequently assumed.

FIG. 4 illustrates the preparation of the photon energy-dependent discrete intensity distributions for further reconstruction. The aim is to combine the scattering images 19(1), 19(2), 19(3) as an XCT measurement data set [symbol] (Kx, Ky, Kz)—also referred to herein as scaled scattering image stack 33. The scaled scattering image stack 33 is prepared for a sample reconstruction via Fourier transformation, which uses an identical discretization of the measurement data (here the intensity values of the scattering images) in the Kx and Ky directions for all Kz values.

As an intermediate step, FIG. 4 shows a non-scaled scattering image stack 35 in which the measured scattering images 19(1), 19(2), 19(3) are combined along the energy frequency component Kz and, thus, fill the three frequency axes with intensity values. The Kx and Ky values correspond in a pixel-dependent manner to the intensity values acquired using the detector 17.

In the context of a scaling step 36, in the scaled scattering image stack 33 of FIG. 4, the photon energy-dependent scattering images are scaled based on a common photon energy in the lateral frequency coordinates Kx, Ky. FIG. 4 correspondingly shows scattering images 19(1)′, 19(2)′, 19(3)′ scaled in the lateral frequency coordinates Kx, Ky. The scaling is based on the fact that the scattering (diffraction) at a structure of the sample is directly proportional to the illumination wavelength (central wavelength λ1, λ2, λ3). In the scaled scattering images 19(1)′, 19(2)′, 19(3)′, the increments in the Kx and Ky directions on which the intensity values are based are adapted to one another for all Kz values (scattering images). I.e., the scaled resolution δ K_x;y for the lateral spatial frequency Kx or Ky is equalized for the scattering images 19(1)′, 19(2)′, 19(3)′. The scaling leads to a reduction in size of the scattering images at low photon energies (Kz values). The scattering images are acquired, e.g., in an energy range from 310 eV to 430 eV and respectively scaled such that the following applies: δ K_x;y (310 eV)=δ K_x;y (430 eV). In this case, all scattering images are scaled to the greatest photon energy (430 eV), as is shown in FIG. 4. Thus, in the example of FIG. 4, the scattering image 19(1)′ remains unchanged at the highest energy and corresponds to the scattering image 19(1) of the non-scaled scattering image stack 35.

Given a constant discretization in the rescaled scattering images, the present physical (spatial) frequencies {K_xy}=pixel→μm⁻¹ can be energetically calibrated. For the calibration, δ K_x;y=p/(zλ) applies here. For the exemplary case of a detector 17 with a pixel array, the pixelization (pitch p) of the detector 17 is, e.g., p=13.5 μm. Given a distance of the detector 17 from the sample P of 230 mm and a wavelength of the measurement beam 12 of λ=2.88 nm (430 eV), a lateral resolution of the physical (spatial) frequency of δ K_x;y=0.0204 μm⁻¹ is assigned to a detector pixel. An exemplary pixel array of 201×201 pixels enables a bandwidth of ΔK_xy=4.08 μm⁻¹ (full width, FW). The addressable spatial frequencies in the exemplary case are correspondingly {K_xy}=[−2.04; 2.04]μm⁻¹. Due to the high photon energies, the depth resolution is δ K_z=0.8066 μm⁻¹ and the bandwidth Δk_z=96.8 μm⁻¹. The measurable physical (spatial) frequencies in the depth direction are {K_z}=[250.0; 346.8]μm⁻¹. Although the spectral resolution in the axial direction δ K_z differs from the spectral resolution in the lateral direction δ K_xy, a subsequent reconstruction is not impaired thereby because a different axis scaling ^{~Ki}=cKi in the Fourier space causes only an inverse scaling ^{~}xi=xi/c of the corresponding axis i in the physical space due to the Fourier transformation. c is a factor here. The inverse scaling is advantageous for the reconstruction because an identical discretization of the lateral and axial components δ k_xy==δ k_z requires the use of very large 3D matrices (entries in #Kx×#Ky×#Kz>201×201×4745) and can significantly increase the computational effort.

As explained in connection with FIG. 1, in the case of a low NA of the detector of, e.g., 0.01 and a coarse discretization of the photon energies (Kz discretization/increment), the observation of a spherical curvature of the “sections” in the Fourier space can be dispensed with also for the case of the use of a planar detector 17.

The result of the scaling step is a combination of measured intensity values with uniform Kx/Ky/Kz increments in the three dimensions of the frequency components Kx, Ky, Kz, which can be read in as XCT measurement data set [symbol] (Kx, Ky, Kz) by a computer for executing a Fourier transformation algorithm, which transforms the multidimensional XCT measurement data set [symbol] (Kx, Ky, Kz) into a sample structure data set O(x, y, z). In other words, a three-dimensional distribution or a “cloud” of intensity values is present in the three-dimensional Fourier space, which can be used as the result of the XCT measurement for reconstruction of the three-dimensional depth structure.

For a three-dimensional Fourier data set (XCT measurement data set [symbol] (Kx, Ky, Kz)) obtained by means of diffractive XCT, the evaluation comprises an algorithmic derivation of the phase of the backscattered radiation. With the derived phase components for the three Fourier axes/frequency space coordinates Kx, Ky, Kz, a sample structure [symbol] (x, y, z) results along the spatial axes x, y, z in the physical space.

The algorithmic implementation of the reconstruction of the sample structure [symbol] (x, y, z) comprises a phase recovery and Fourier transformation(s):

[symbol]

(Kx, Ky, Kz)→phase recovery/Fourier transformation(s)→ [symbol] (x, y, z)

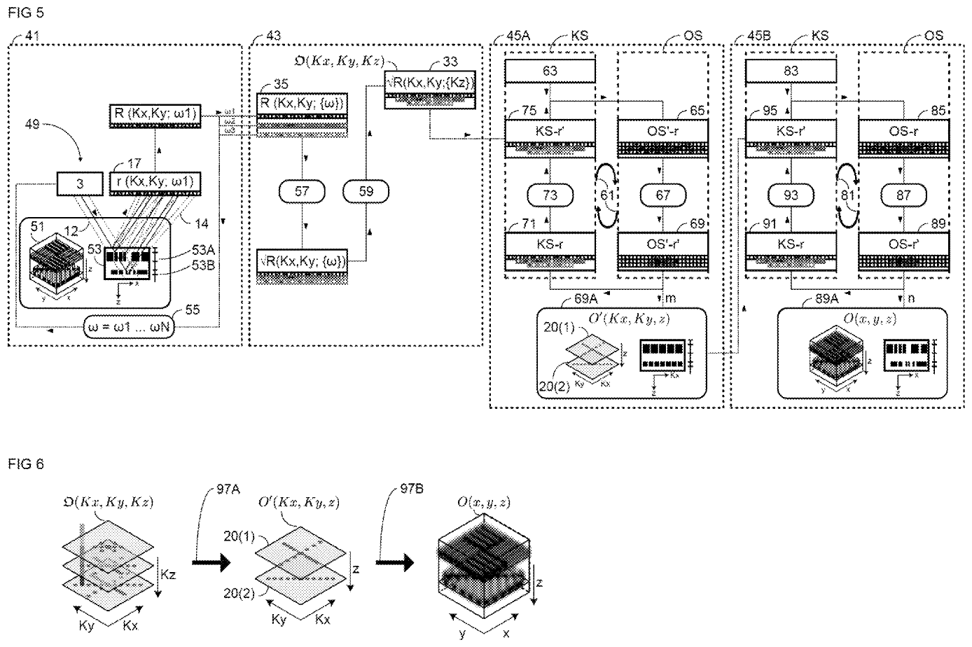

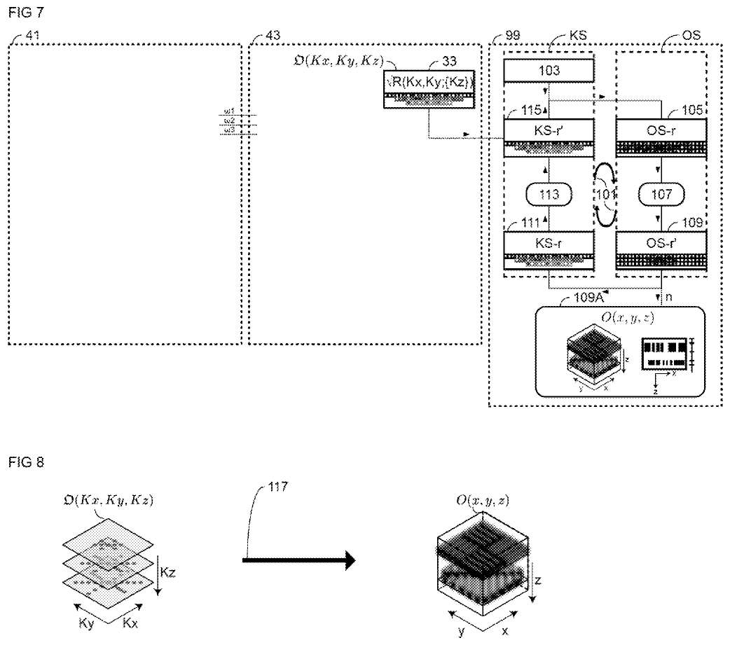

As recognized by the inventors, the reconstruction can be carried out sequentially, e.g., first for the axial Fourier axis (frequency space coordinate Kz) and then for the lateral Fourier axis(s) (frequency space coordinates Kx and Ky), or simultaneously, i.e., in parallel, for all three Fourier axes (frequency space coordinates Kx, Ky, Kz). An exemplary sequential reconstruction is described in the following in connection with FIGS. 5 and 6. An exemplary simultaneous reconstruction of all three Fourier axes is described in the following in connection with FIGS. 7 and 8.

In the flow diagram of FIG. 5, the measurement processes and data processing steps of the measurement data explained above are summarized in dashed boxes 41 and 43. Furthermore, an exemplary sequential 1D-2D evaluation of the measurement data [symbol] (Kx, Ky, Kz)—first one-dimensionally in the depth direction and then two-dimensionally in the lateral directions—is illustrated in the dashed boxes 45A and 45B, wherein the measurement data [symbol] (Kx, Ky, Kz) are based on scattering images that were obtained by means of diffractive XCT using spectrally structured EUV/X-ray measurement beams 12.

In FIG. 5, a cycle of DXCT measurement processes 49 for obtaining DXCT scattering images is illustrated at the bottom left in box 41. For a plurality of respectively specifically spectrally structured EUV/X-ray measurement beams 12 of a radiation source 3, one-or two-dimensional intensity distributions of the EUV/X-ray radiation 14 backscattered from the sample into the solid angle of the detector 17 are respectively acquired in 1 to N measurement processes using the detector 17.

In FIG. 5, a sample is shown exemplarily in perspective schematically in a three-dimensional layer structure 51 in the physical space (x, y, z). The scattering of the EUV/X-ray measurement beam 12 emanating from the radiation source 3 is illustrated on the basis of an exemplary sectional view 53 of the sample. The spatially coherent EUV/X-ray measurement beam 12 can be spectrally structured for the N measurement processes, so that the EUV/X-ray measurement beam 12 can be set for several narrowband-structured frequency ranges, e.g., ω=ω1bis ω=ωN (step 55) and, in this way, N spectrally resolved DXCT measurement processes 49 can be carried out (iteratively). For the sectional view 53 shown exemplarily, the EUV/X-ray measurement beam 12 is scattered at two layer-like structures 53A, 53B within the sample.

Complex reflectivities of the layer-like structures 53A, 53B are the basis for the scattering processes within the sample and lead to the illumination of the laterally resolving detector 17 (1D/2D pixel arrangement) arranged in the far field with the backscattered radiation (scattered radiation 14). The complex reflectivity can be described in the form of spectrally resolved reflectivity coefficients r(Kx, Ky; ω) and assigned to the detector pixels. An intensity scattering image, i.e., squares of the magnitude of the scattered field, is measured with the detector 17 for each measurement process (for ω=ω1 bis ω=ωN), which in the example of FIG. 5 each represent a two-dimensional distribution of the measured intensity with intensity values R(Kx, Ky; ω1 . . . ωN). In other words, the detector 17 acquires intensities of the diffracted EUV/X-ray radiation (scattered radiation 14) at a plurality of positions in the far field, wherein the spectral phase at the respective measurement location (pixel of the detector) is not known. The scattering images 19 are shown in FIG. 5 in exemplary sectional views as pixel arrays of different gray shades. The size of the detector 17 corresponds to the maximum numerical aperture NA, which in turn sets the maximum lateral resolution.

As discussed in connection with FIG. 4 and illustrated in box 43 of FIG. 5, the scattering images can be combined in a non-scaled scattering image stack 35. For preparation for the reconstruction, the square roots of the measured intensity values—data points √(R(Kx, Ky; ω1 . . . ωN))—can be taken (step 57). Furthermore, in step 59, the energy values (ω1 to ωN) of the scattering images are converted into Kz values (Kz1 to KzN) and a uniform scaling is introduced into kx and ky for the Fourier transformation-data points √(R(Kx, Ky; Kz1. . . KzN)). Thus, for the reconstruction, XCT measurement data [symbol] (Kx, Ky, Kz) are given that correspond to the spectral (energy-dependent) reflectivities r in the frequency space without phase information.

Although an amplitude of the field reflectivity |r(K)|=√(R(Kx, Ky; Kz1 . . . KzN)) can be determined from the known intensity reflectivity R(K)=|r(K)|², the interferences between the buried layers and those relative to the sample surface remain indistinguishable for the XCT analysis (derivation of the depth structure) without knowledge of the phase information, with the corresponding presence of artifacts.

For the reconstruction of the sample structure, the phase eⁱ^{^{φ}}^{(K)} (in the Fourier space) or e^{iθ(Z)} (in the physical space) is to be reconstructed, whereby the reflectivities in the physical space r(z) e^{iθ(Z)} and in the Fourier space r(k) e^{iφ(K)} are determined completely (in particular artifact-free).

Methods for the reconstruction of the phase usually operate iteratively by repeatedly executing a loop of Fourier transformation, inverse Fourier transformation, and setting associated necessary boundary conditions (constraints) in the Fourier space and in the physical space, wherein the boundary conditions are selected in particular for effecting/accelerating the convergence of the phase reconstruction. For example, algorithms such as the Gerchberg-Saxton algorithm and/or the feedback algorithm hybrid input-output can be used. The above basic principle for convergence applies generally to a phase reconstruction in 1D, 2D or 3D. For the XCT, in particular for a three-stage algorithm for one-dimensional phase reconstruction in the XCT, reference is made exemplarily to the scientific publications mentioned in the introduction with regard to the phase reconstruction and derivation of the depth structure.

In the serial approach shown in FIG. 5, the reconstruction of the sample structure O(x, y, z) takes place stepwise. The reconstruction (box 45A, 45B) explained in detail in the following makes use of the fact that a pixel-specific intensity reflectivity “R(ω)” can be derived from a plurality of scattering images for a pixel (given by Kx and Ky). The serial approach reconstructs from the XCT measurement data [symbol] (, Ky, Kz), which are given in the 3D Fourier space, thereby initially the axial structure of the scattering images in a partial physical space (Kx, Ky, z) pixel by pixel (box 45A). In this case, e.g., the known PR-XCT algorithm can be applied individually point by point, i.e., for each point (Kx, Ky) in the scattering images. Thereby, in a first step, a one-dimensional obtaining of the phase can be applied to the stack of scaled scattering images for a single lateral data point in order to obtain phase information of the third Fourier component (axial frequency space coordinate Kz). The result of the calculation are depth-resolved scattering images/diffractograms (20(1), 20(2)), i.e., partially reconstructed scattering images, which can be combined into a partially reconstructed sample structure O′(Kx′, Ky′, z) in the partial physical space (Kx, Ky, z). From the depth-resolved scattering images/diffractograms (20(1), 20(2)), in the second step, the lateral structure of the sample structures O(x, y, z) can be reconstructed individually with a PR-2D algorithm for each depth z (box 45B).

An advantage of the serial reconstruction approach can be the independent use of two established algorithm approaches and the decomposition of the 3D reconstruction into low-dimensional problems. The method of the serial reconstruction approach can be applied in particular when layer-like samples are present that enable a separate calculation of axial and lateral structure because they are self-referencing and provide sufficient information about the axial structure in the individual points of the detector 17. However, the serial reconstruction approach does not benefit from the redundant information that is present in the 3D Fourier space, whereby the convergence of the reconstruction can be reduced and the susceptibility to noise can be increased.

The first step of the serial reconstruction approach (XCT reconstruction step) implemented exemplarily in the dashed box 45A can be illustrated as follows:

[symbol]

(Kx, Ky, Kz)→XCT-PR/axial structure→ [symbol] (Kx, Ky, Kz) e^{iφ}^{_{axial (Kz(Kx, Ky))}}→FT/Kz→O′(Kx, Ky, z) e^{iθ}^{_{axial (z(Kx, Ky))}}

In box 45A, the repeated execution of Fourier transforms and inverse Fourier transforms and, thus, the change between Fourier space KS (Fourier space reflectivities KS-r) and partial physical space OS′ (partial physical space reflectivities OS′-r) is illustrated by arrows 61. The starting point is the scaled XCT measurement data set [symbol] (, Ky, Kz)—in box 45A: Ks-r, on which a random phase 63 for Kz is initially applied for Fourier transformation into the partial physical space OS′ (result: OS′-r (Kx, Ky, z) 65). In the partial physical space OS′, for example, restrictions (constraints) 67 for z are introduced for back transformation into the Fourier space KS (intermediate result: OS′-r′ (Kx, Ky, z) 69). In the Fourier space, a new KS-r 71 results, on which, for example, restrictions (constraints) 73 for Kz are introduced for the next transformation into the partial physical space OS′ (intermediate result KS-r′ (Kx, Ky, Kz) 75). After m iterations, one-dimensionally reconstructed depth-resolved scattering images/diffractograms O′(Kx, Ky, z) 69A result in the partial physical space OS′. These represent the input of the subsequent two-dimensional reconstruction in box 45B, from which the sample structure O(x, y, z) 89A results.

Exemplary parameters of the one-dimensional phase recovery algorithm comprise 2×120 iterations HIO in the first step, 500 iterations HIO in the second step and 500 iterations GS in the third step. An exemplary discretization of the scattering images is 0.2 μm per pixel.

With regard to the one-dimensional evaluation step of the measurement data [symbol] (Kx, Ky, Kz) outlined in box 45A, it is pointed out that OCT/XCT evaluation methods are known that enable a precise reconstruction of the axial layer structure for complex interferences (see, e.g., the publication by S. Fuchs et al. mentioned at the beginning). With so-called “phase retrieval” (PR) XCT algorithms, the axial structure of the sample and the complete spectral phase are derived from XCT measurement data generated with broadband EUV radiation by reconstructing the scattering process. The phase carries, inter alia, information about the absorption and dispersion of the materials present in the sample as well as about the incidence geometry and the refractive index of the dominant material of a layer. In order to derive the axial layer structure of the sample from the reflected spectrum, in the XCT evaluation method, a one-dimensional Fourier transformation (frequency space coordinates Kz) of the acquired spectrum into the physical space (here the depth direction z) is carried out in a multi-stage algorithm, for example.

The second step of the serial reconstruction approach (lateral reconstruction step) implemented exemplarily in the dashed box 45B can be illustrated as follows:

O′(Kx, Ky, z)→“CDI”-PR/lateral structure→O′(Kx, Ky, z) e^{iφ}^{_{lateral (Kx(z), Ky(z))}}→FT/Kx Ky→O(x, y, z) e^{iθ}^{_{lateral (x(z), y(z))}}

In the second step, a two-dimensional phase calculation, e.g., similar to a CDI phase reconstruction, can be performed separately for each z in order to reconstruct the lateral structure.

In box 45B, the repeated execution of Fourier transforms and inverse Fourier transforms and, thus, the change between Fourier space KS (Fourier space reflectivities KS-r) and physical space OS (physical space reflectivities OS-r) is illustrated by arrows 81. The reconstructed depth-resolved scattering images/diffractograms O′(Kx, Ky, z) 69A located in the partial physical space OS′-r form the starting point for the reconstruction (see box 45A). These diffractograms are fed to the two-dimensional phase calculation (box 45B in FIG. 5) as KS-r (form: KS-r (Kx, Ky, z) 95). A random phase 83 for Kx and Ky is initially generated for Fourier transformation into the physical space OS (result: OS-r (x, y, z) 85). In the physical space, restrictions (constraints) 87 for x and y are introduced for back transformation into the Fourier space KS (intermediate result: OS-r′ (x, y, z) 89). In the Fourier space or partial physical space, this results in a new KS-r (form: KS-r (Kx, Ky, z) 91), on which restrictions (constraints) 93 for Kx and Ky are introduced for the next Fourier transformation into the physical space OS (intermediate result: KS-r′ (Kx, Ky, Kz) 95). As mentioned, algorithms for two-dimensional reconstruction in the second step can be derived, for example, from CDI algorithms. After n iterations, this results, in the physical space OS, in a three-dimensional reconstruction of the structure O(x, y, z) 89A of the three-dimensional sample.

Algorithms for phase reconstruction, such as known from the XCT for a one-dimensional data set and outlined above, can be analogously expanded to two-or three-dimensional data sets. These variants are referred to herein as phase reconstruction in 2D (PR2D) or in 3D (PR3D), wherein the phase reconstruction in 1D (PR 1D) refers to the known XCT analysis. Fundamentally, these algorithms differ by the dimensionality of the Fourier transformation: 1D, 2D or 3D. Besides that, they are almost identical in executing the boundary conditions (constraints). Although the reconstruction for three-dimensional samples may be more complex, as the equation system is greater due to the third power, in principle, however, better results can be achieved (more quickly) under certain circumstances due to additional redundant information. Depending on the sample, different algorithms can be used in the phase reconstruction, such as, e.g., the Gerchberg-Saxton (GS) or error reduction (ER) algorithm, the hybrid input-output (HIO) algorithm, the hybrid projection-reflection (HPR) algorithm or the relaxed averaged alternating reflection (RAAR) algorithm, a combination thereof, or AI algorithms. Exemplary parameters of the two-dimensional algorithm for phase recovery comprise 3000 iterations of a feedback RAAR algorithm.

FIG. 6 summarizes the sequential reconstruction of the sample structure. Starting from the originally measured (Fourier) data set [symbol] (, Ky, Kz) of the scattering images, a one-dimensional phase reconstruction (PR-OCT algorithm) is carried out for each lateral data point (Kx, Ky) (XCT reconstruction step 97A). This results in depth-resolved scattering images/diffractograms O′(Kx, Ky, z), in other words partially (i.e., in Kz) reconstructed scattering images. Similar to a two-dimensional CDI phase recovery algorithm, then a lateral reconstruction of the depth-resolved scattering images/diffractograms O′(Kx, Ky, z) can be carried out in order to calculate the sample structure O(x, y, z) (lateral reconstruction step 97B). The depth-resolved diffractograms (20(1), 20(2)) shown in FIG. 6 represent, for example, diffractograms of the depth position z contributing to the sample structure data set O(x, y, z), the diffractograms being identified according to a signal evaluation step.

As the inventor has recognized, for certain samples, this can result in advantages, which simplify and/or accelerate the second step of the reconstruction. Due to the order of the reconstruction initially one-dimensional, subsequently two-dimensional-first axial structures are reconstructed. This enables spectral modulations to be analyzed for obtaining depth structure information. As the depth profile was obtained for each lateral position (Ky, Ky), the signal strength belonging to a z-value (depth value) is an indication of the presence of lateral structures of the sample in this z-region (layer information). In conclusion, there is no lateral structure (layer information) at depth values, which have no significant or a low signal contribution or signal noise. This enables a limitation of the lateral reconstruction to the depth values with signal (significant signal contribution) and, thus, leads to a faster calculation of the object structure.

The axial phase reconstruction furthermore shifts the modulation-free signal automatically onto the surface at z=0. As a result, the depth-resolved scattering images/diffractograms O′(Kx, Ky, z) are freed from the intensive incident and low-modulation radiation. At the same time, noise, which likewise has no specific spectral modulation frequency, is shifted onto the surface at z=0. These aspects can significantly increase the contrast in the depth-resolved scattering images/diffractograms O′(Kx, Ky, z) and simplify the lateral reconstruction of the sample in the second step.

For completeness, it is mentioned that an exchange of the order of the reconstruction by PR-XCT and PR2D is also possible and can be advantageous, for example, for particularly laterally structured samples.

In the approach of parallel reconstruction, instead of a serial calculation, a parallel calculation in all three dimensions is used, in which the axial structure and the lateral structure are not determined successively, but rather simultaneously with a PR3D algorithm. This reconstruction approach can be applied in particular to samples with an unknown and also stamp-like or self-referencing structure.

For the reconstruction of the sample structure, e.g., a combination of a RAAR algorithm and a HIO algorithm with, e.g., a total of 3000 iterations can be used. For example, the three-dimensional data set [symbol] (Kx, Ky, Kz) of the scattering images can be initially expanded with 128∧3 entries with the aid of “zero padding”, e.g., to 256∧3 entries. The feedback in the HIO algorithm is, e.g., β=0.75. The threshold value for a so-called shrink wrap of an aperture to be applied is, for example, 6%. The remaining parameters can relate to those of the serial reconstruction approach.

The data can additionally be corrected for a parallel reconstruction. The illumination beam k(i) reflected at the surface of the sample superposes, as a specular reflex, the actual scattering images (Kx, Ky, Kz) at (Kx, Ky)~0 and can, thus, disturb the signal to be measured of the actual diffraction or scattering at the sample. With the aid of a, e.g., circular mask, an inner region of the measurement data at (Kx, Ky)~0 can be set to, e.g., zero, whereby a reconstruction of the dominant illumination function or of the illumination beam k(i) can be avoided. (It is pointed out that such a correction is not necessary in a serial reconstruction because the axial PR-XCT algorithm shifts modulation-free components of the depth reconstruction automatically into the DC component or into the surface at z=0). In the serial approach, depth-resolved scattering images/diffractograms O′(Kx, Ky, z) are corrected by the illumination beam k(i) and freed from the background.)

In box 99 of FIG. 7, the repeated execution of Fourier transforms and inverse Fourier transforms and, thus, the change between Fourier space KS (Fourier space reflectivities KS-r) and physical space OS (physical space reflectivities OS-r) is illustrated by arrows 101 for the approach of parallel reconstruction. The starting point is, as in the serial reconstruction, the scaled XCT measurement data set [symbol] (Kx, Ky, Kz). the scaled XCT measurement data set [symbol] (Kx, Ky, Kz) can be obtained, e.g., by a plurality of measurement processes, as illustrated in boxes 41 and 43 in connection with FIG. 5. For the associated description, reference is made to the preceding description of FIG. 5. In box 99, there are the reflectivities in the Fourier space KS-r, on which a random phase 103 for Kx, Ky and Kz is initially applied for the Fourier transformation into the physical space OS (result: OS-r(x, y, z) 105). In the physical space, restrictions (constraints) 107 for x, y and z are introduced for the back transformation into the Fourier space KS (intermediate result: OS-r′ (x, y, z) 109). In the Fourier space, this results in a new KS-r 111, on which restrictions (constraints) 113 for Kx, Ky and Kz are introduced for the next transformation into the physical space OS (intermediate result: KS-r′ (Kx, Ky, Kz) 115). As mentioned, algorithms for three-dimensional reconstruction can be derived, for example, starting from the one-dimensional PR-XCT algorithm or the two-dimensional CDI algorithm. After n iterations, this results, in the physical space OS, in a three-dimensional reconstruction of the structure O(x, y, z) of the three-dimensional sample.

FIG. 8 summarizes the parallel reconstruction. Starting from the original measured (Fourier) data set [symbol] (Kx, Ky, Kz) of the scattering images, a three-dimensional phase reconstruction (PR3D algorithm) is carried out for each data point (Kx, Ky, Kz), what results in the sample structure O(x, y, z). The parallel approach reconstructs the 3D structure O(x, y, z) of the sample directly from the known 3D Fourier space [symbol] (Kx, Ky, Kz) without any intermediate step with the aid of the PR3D algorithm (3D reconstruction step 117). The parallel approach has the advantage that even more complex, in particular also non-layer-like, samples can be reconstructed. Moreover, the parallel approach can utilize redundancies for sample reconstruction within the 3D Fourier space. A prerequisite for the parallel reconstruction is an evaluation unit which can implement the high computational effort through the 3D calculation and the use of 3D matrices.

In comparison between serial and parallel reconstruction, with the serial approach, e.g., a larger region of the lateral structure, i.e., a larger field of view, can be reconstructed if a higher or better diffraction contrast of the depth-resolved scattering images/diffractograms O′(Kx, Ky, z) is present in the serial reconstruction in comparison to the original 3D Fourier space [symbol] (Kx, Ky, Kz) in the parallel reconstruction. A better diffraction contrast and the thereby improved spectral resolution δ K_x or δ K_y can result for the serial approach in a larger field of view Δx′~1/δ K_x or Δy′~1/δ K_y in the physical space. In the serial approach, the original measurement data [symbol] (, Ky, Kz) are automatically corrected by the application of the PR-XCT algorithm. A false correlation or a noisy background, which cannot have a specific spectral modulation, is shifted by the PR-XCT algorithm through its Fourier transformation into the DC peak, whereby the depth-resolved scattering images/diffractograms O′(Kx, Ky, z) are corrected with respect to the original 3D Fourier space O(Kx, Ky, Kz) and allow the diffraction contrast to increase.

The concepts disclosed herein were explained above in detail for three-dimensional XCT measurement data sets. As mentioned initially, the concepts disclosed herein can likewise be applied to the generation and evaluation of two-dimensional XCT measurement data sets. In this case, the positions of the intensity values in a two-dimensional frequency space (Kx or Ky, Kz) are specified, thus, are determined on the one hand by a lateral frequency space coordinate (Kx or Ky) and on the other hand an axial frequency space coordinate (Kz). In the case of two-dimensionally structured samples, for example, the acquisition of a one-dimensional scattering image using a line detector can provide sufficient lateral structure information that can be derived together with the depth information. The description of the reconstruction, as it is explained exemplarily in connection with FIGS. 5 to 8, can be adapted and carried out with regard to the lateral frequency space coordinates correspondingly to the reconstruction of a single lateral frequency space coordinate (of a one-dimensional scattering image).

The explanations in connection with the section of the Ewald sphere shown in FIG. 1 likewise already illustrate a 2D scattering analysis, as it can be performed, e.g., for a symmetrical sample using a line detector according to the concepts disclosed herein.

Generally, for EUV/X-ray sources with a higher spatial coherence, laterally larger regions of the sample can be examined and reconstructed.

Furthermore, even further regions of the sample can be examined and reconstructed if different regions of the sample are coherently illuminated, e.g., in the scanning method, and these regions partially overlap coherently. This is referred to as the so-called ptychography.

In FIG. 9, the already mentioned approach of the extension of the XCT measurement data (exemplarily in the form of scattering image stacks) by scanning a plurality of surface sections 120, 130, 140 of the sample is illustrated. The surface sections 120, 130, 140 are shown in two lateral dimensions x and y together with the schematically indicated examined sample depth in the z-direction (examined volume regions 122, 132, 142). To each examined surface section 120, 130, 140, there is assigned a scattering image stack 124, 134, 144.

The sampling takes place, for example, as follows: After the iterative generation of the scattering images was run through at a first surface section 120 with the reference point xy_1 and a scattering image stack 124 was generated for the associated volume region 122 of the sample, a displacement, e.g., of the sample to the reference point xy_2 is carried out for an irradiation of the volume region 132. In FIG. 9, a partial overlap of the surface sections 120 and 130 can be seen; correspondingly, the volume regions 122 and 132 and the scattering image stacks 124 and 134 also overlap. Exemplarily, in FIG. 9, the displacement takes place in both directions x and y. A further displacement enables the generation of the scattering image stack 144 for the reference point xy_3 and the volume region 142.

Based on the intensity values of the scattering image stacks 124, 134, 144, a common XCT measurement data set can then be generated and evaluated for the entire scanned surface region. In other words, the EUV/X-ray measurement beam can be irradiated onto a plurality of spatially laterally extended surface sections of the sample that adjoin one another or partially overlap one another. The acquired intensity values of the scattering image stacks assigned to the surface sections can be combined to form the three-dimensional XCT measurement data set [symbol] (Kx, Ky, Kz).

Alternatively to the sequential generation of adjacent scattering image stacks that adjoin one another or in particular partially overlap one another, the scanning can take place in one or two directions in each case for an adjusted (narrowband) structured frequency range, so that extended scattering images for the plurality of (narrowband) structured frequency ranges are sequentially acquired and subsequently combined to form a common scattering image stack.

It is explicitly emphasized that all features disclosed in the description and/or the claims are to be regarded as separate and independent of one another for the purpose of the original disclosure as well as for the purpose of restricting the claimed invention independent of the feature combinations in the embodiments and/or the claims. It is explicitly stated that all range specifications or specifications of groups of units disclose any possible intermediate value or subgroup of units for the purpose of the original disclosure as well as for the purpose of restricting the claimed invention, in particular also as a limit of a range specification.

1. Method for generating a multidimensional XCT measurement data set ( [symbol] (Kx, Ky, Kz)) of a sample (P) using spectrally multi-structured scattering imaging, comprising the steps:
providing EUV/X-ray radiation (6) with a broadband spectrum in the EUV to X-ray spectral range;
generating a plurality of scattering images (19), wherein each of the plurality of scattering images (19) is generated using a measurement process that comprises the steps:
a) structuring the broadband spectrum of the EUV/X-ray radiation (6) as a structured frequency range for providing an EUV/X-ray measurement beam (12) with a measurement beam spectrum, which comprises at least one of a plurality of narrowband-structured frequency ranges, wherein at least one axial frequency space coordinate (Kz) in the frequency space (Kx, Ky, Kz) is assigned to each of the narrowband-structured frequency ranges;
b) irradiating the EUV/X-ray measurement beam (12) onto a spatially laterally extended surface section of the sample (P);
c) acquiring scattered radiation, which is back-scattered by the sample (P), using a detector (17), which outputs intensity values for the structured frequency range associated with the measurement process, to which intensity values at least one lateral frequency space coordinate (Kx, Ky) in the frequency space (Kx, Ky, Kz) is assigned, respectively, wherein the intensity values form the scattering image (19) for the associated measurement process; and
combining the intensity values to form the multidimensional XCT measurement data set ( [symbol] (Kx, Ky, Kz)), wherein the positions of the intensity values in the frequency space (Kx, Ky, Kz) are given by at least one lateral frequency space coordinate (Kx, Ky) and an axial frequency space coordinate (Kz).

2. The method according to claim 1, wherein the scattering images (19) are detected in a plurality of measurement processes with different structured frequency ranges; and/or
wherein the plurality of scattering images (19) is acquired for a plurality of narrowband-structured frequency ranges, respectively, in particular for a plurality of central wavelengths.

3. The method according to claim 1, wherein the EUV/X-ray measurement beam (12) is spectrally structured for N measurement processes differently, in particular is set for several narrowband-structured frequency ranges, to perform N differently spectrally resolved measurement processes.

4. The method according to claim 1, wherein the broadband spectrum is structured by a monochromator diffracting a narrowband frequency range out of the EUV/X-ray radiation (6), the narrowband frequency range propagating as the EUV/X-ray measurement beam (12) along an optical beam path (7) to the sample (P).

5. The method according to claim 1, wherein the scattered radiation is acquired by detecting the scattered radiation of an associated structured frequency range, which is reflected by the sample, in a lateral dimension using a line detector or in two lateral dimensions using a two-dimensional detector, and outputting it as a one-dimensional or two-dimensional scattering image.

6. The method according to claim 1, wherein the at least one lateral frequency space coordinate (Kx, Ky) is specified by parameters of the EUV/X-ray measurement beam and parameters of the measurement process, and/or wherein the axial frequency space coordinate (Kz) is given by the photon energy of the radiation acquired at a lateral frequency space coordinate (Kx, Ky).

7. The method according to claim 1, wherein the intensity values of a scattering image of a measurement process are projected onto an axial frequency space coordinate assigned to the measurement process, in particular onto an average axial frequency space coordinate assigned to the respective measurement process, for example, given by:
Kz=(2 sin α) k; wherein k is a wave vector assigned to a narrowband-structured frequency range, and α is an angle of incidence of the EUV/X-ray measurement beam (12) to the surface section of the sample (P).

8. The method according to claim 1, wherein each of the intensity values of a scattering image of a measurement process is projected onto an axial frequency space coordinate (Kz) of a plurality of axial frequency space coordinates, in particular in dependence on the at least one lateral frequency space coordinate of each of the intensity values; and/or
wherein based on projected axial frequency space coordinates (Kz), axially uniform scattering images are composed that comprise intensity values from scattering images acquired in different measurement processes at a same axial frequency space coordinate (Kz).

9. The method according to claim 1, wherein a plurality of axial frequency space coordinates is assigned to the associated structured frequency range for at least one measurement process, and in a measurement process, intensity values for a plurality of scattering images are obtained by assigning the intensity values to respectively associated axial frequency space coordinates of a narrowband-structured frequency range.

10. The method according to claim 1, wherein a first subgroup of measurement processes is carried out at a first relative position between the incident EUV/X-ray measurement beam (12) and the spatially laterally extended surface section of the sample (P) and a second subgroup of measurement processes is carried out at a second relative position between the incident EUV/X-ray measurement beam (12) and the spatially laterally extended surface section of the sample (P); and
furthermore, the multidimensional XCT measurement data set ( [symbol] (Kx, Ky, Kz)) is formed from the intensity values of the first subgroup and the second subgroup in the frequency space (Kx, Ky, Kz), in particular taking into account the axial frequency space coordinates (Kz).

11. The method according to claim 1, wherein the EUV/X-ray measurement beam (12) is irradiated onto a plurality of spatially laterally extended surface sections of the sample (P) that adjoin one another or partially overlap one another, and the acquired intensity values of the scattering images assigned to the surface sections are combined to form together the three-dimensional XCT measurement data set ( [symbol] (Kx, Ky, Kz)).

12. The method according to claim 1, wherein the plurality of scattering images form, combined as a two-dimensional Fourier measurement data set or as a three-dimensional Fourier measurement data set, the multidimensional XCT measurement data set ( [symbol] (Kx, Ky, Kz)).

13. A computer-implemented method for reconstructing a multidimensional structure of a sample (P) from a multidimensional XCT measurement data set ( [symbol] (Kx, Ky, Kz)), comprising the steps:
reading, into a processor (21B), intensity values of a multidimensional XCT measurement data set ( [symbol] (Kx, Ky, Kz)), wherein positions of the intensity values in the frequency space (Kx, Ky, Kz) are given by at least one lateral frequency space coordinate (Kx, Ky) and an axial frequency space coordinate (Kz); and
executing, with the processor (21B), a Fourier transformation algorithm, which transforms the multidimensional XCT measurement data set (O(Kx, Ky, Kz)) into a sample structure data set (O(x, y, z)), wherein the sample structure data set ( [symbol] (x, y, z)) comprises, in a physical space (x, y, z), a depth direction coordinate (z) of the sample (P), which is assigned to the axial frequency space coordinate (Kz), and at least one lateral coordinate (x, y) of the sample (P), which is assigned to the at least one lateral frequency space coordinate (Kx, Ky).

14. The computer-implemented method according to claim 13, further comprising
a scaling step, in which for each of the plurality of axial frequency space coordinates (Kz) of the frequency space (Kx, Ky, Kz), intensity values in the at least one lateral frequency coordinate (Kx, Ky) are scaled based on a common photon energy, so that in particular the increments in the at least one lateral frequency coordinate (Kx, Ky), on which the multidimensional XCT measurement data set ( [symbol] (Kx, Ky, Kz)) is based, are adapted to one another for all axial frequency space coordinates (Kz); and/or
a field calculation step, in which the square root of each intensity value is taken.

15. The computer-implemented method according to claim 13, wherein the Fourier transformation algorithm is configured to determine a phase of the detected scattered light by Fourier transformations, wherein in particular the phase is reconstructed iteratively by repeatedly executing a loop with at least one Fourier transformation, at least one inverse Fourier transformation, and setting boundary conditions in the Fourier or physical space for the Fourier transformation and/or the inverse Fourier transformation.

16. The computer-implemented method according to claim 13, wherein the Fourier transformation algorithm comprises
an XCT reconstruction step (97A) for one-dimensional phase reconstruction in a depth direction coordinate (z) of the physical space (x, y, z), which derives, based on the axial frequency space coordinate (Kz) for lateral positions (Kx, Ky), a partially reconstructed sample structure (O′(Kx′, Ky′, z)), which comprises a plurality of depth-resolved diffractograms (20(1), 20(2)), wherein the XCT reconstruction step in particular comprises a 1D phase reconstruction XCT algorithm; and
a lateral reconstruction step (97B) for one-or two-dimensional phase reconstruction in at least one lateral coordinate (x, y), which derives the sample structure data set (O(x, y, z)) based on the at least one lateral frequency space coordinate (Kx, Ky) and at least one subgroup of the plurality of depth-resolved diffractograms (20(1), 20(2)).

17. The computer-implemented method according to claim 16, further comprising
a signal evaluation step, in which accumulated signal contributions of the depth-resolved diffractograms (20(1), 20(2)) are calculated in order to identify depth positions (z) contributing to the sample structure data set (O(x, y, z)); and
wherein the subgroup of the plurality of depth-resolved diffractograms (20(1), 20(2)) for the lateral reconstruction step comprises the depth-resolved diffractograms (20(1), 20(2)) of the contributing depth positions (z).

18. The computer-implemented method according to claim 13, wherein the Fourier transformation algorithm comprises
a 3D reconstruction step (117) for multidimensional phase reconstruction in a depth direction coordinate (z) of the sample structure data set (O(x, y, z)) and at least one lateral coordinate (x, y) of the sample structure data set (O(x, y, z)) based on the axial frequency space coordinate (Kz) and the at least one lateral frequency space coordinate (Kx, Ky).

19. The computer-implemented method according to claim 18, wherein a region of direct reflection is excluded from the common reconstruction.

20. The computer-implemented method according to claim 13, wherein a plurality of scattering images (19) is fed, combined as a two-dimensional Fourier measurement data set or as a three-dimensional Fourier measurement data set, to the computer-implemented method, wherein the scattering images (19) were detected in a plurality of measurement processes with different structured frequency ranges.

21. A device for obtaining a multidimensional XCT measurement data set (O(Kx, Ky, Kz)) of a sample (P), comprising:
an EUV/X-ray radiation source (3) for generating broadband EUV/X-ray radiation (6);
an optical device (11) for structuring the broadband spectrum of the EUV/X-ray radiation (6) as a structured frequency range and for outputting an EUV/X-ray measurement beam (12) with a measurement beam spectrum, which comprises at least one of a plurality of narrowband-structured frequency ranges for a measurement process, wherein at least one axial frequency space coordinate (Kz) in the frequency space (Kx, Ky, Kz) is assigned to the narrowband-structured frequency ranges;
a sample holder (10) for supporting the sample (P) at an angle of incidence of the EUV/X-ray measurement beam (6) onto a surface section of the sample (P);
a focusing element (15), which is configured to form a spatially lateral beam extension parameter of the EUV/X-ray measurement beam (12) on the surface section of the sample (P), wherein the beam extension parameter is in a range from one micrometer to several hundred micrometers, measured based on the FWHM intensity of the EUV/X-ray measurement beam (12);
a detector (17), which is arranged to record intensity values in the far field with respect to the sample (P); and
a control device (21) that
is connected to the optical device (11) for structuring the broadband spectrum for setting the structured frequency range for a plurality of measurement processes and to the detector (17) for reading out the intensity values, and
is configured to compose the multidimensional XCT measurement data set (O(Kx, Ky, Kz)) from the intensity values.

22. The device according to claim 21, wherein the EUV/X-ray radiation source (3) is a synchrotron-based or laser-based radiation source; and/or
wherein the sample holder (10) is configured
for supporting the sample (P) for adjusting the angle of incidence of the EUV/X-ray measurement beam (12); and/or
for supporting the sample (P) in the focus or in front of the focus of the focusing element (15); and/or
for scanning the sample by laterally moving the sample (P) with respect to the EUV/X-ray measurement beam (12).

23. The device according to claim 21, wherein the optical device (11) is configured to set different structured frequency ranges, in particular a plurality of narrowband-structured frequency ranges, in particular with a plurality of central wavelengths, for a detection of the scattering images (19) in a plurality of measurement processes.

24. The device according to claim 21, wherein the device for obtaining a multidimensional XCT measurement data set is configured to spectrally structure the EUV/X-ray measurement beam (12) for N measurement processes differently, in particular to set it for several narrowband-structured frequency ranges, to perform N differently spectrally resolved measurement processes.

25. The device according to claim 21, wherein the optical device (11) is configured as, in particular grating-based, grating pair-based or multi slit-based, mono-or multi-chromator; and
wherein in particular
a grating-based or grating pair-based mono-or multi-chromator is rotatably supported for adjusting a central frequency of the structured frequency range; and/or
a multi slit-based mono- or multi-chromator is adjustable for adjusting a central frequency of the structured frequency range with respect to a multi slit configuration, such as slit width; and/or
wherein the focusing element (15) is arranged upstream or downstream of the optical device (11) for structuring the broadband spectrum.

26. The device according to claim 21, wherein the focusing element (15) is configured to form a spatially lateral beam extension parameter of the EUV/X-ray measurement beam (12) on a surface section of the sample (P), which spatially lateral beam extension parameter defines a lateral dimension of the sample (P) and correspondingly a lateral frequency component (Kx, Ky) and is in particular in a range from 1 μm to 1 mm, in particular from 10 μm to 500 μm, measured based on the FWHM intensity of the EUV/X-ray measurement beam (12).

27. The device according to claim 21, wherein the detector (17)
is configured to record one-dimensional scattering images (19) as a line detector for acquiring a series of intensity values or to record two-dimensional scattering images (19) as a two-dimensional detector for acquiring an array of intensity values; and/or
is rotatably supported for aligning an acquired lateral dimension; and/or
wherein the intensity values of a measurement process acquired by the detector (17) each form a scattering image (19) or an intensity value acquired by the detector (17) is assigned to one of a plurality of scattering images in dependence on an axial frequency space coordinate (Kz) assigned to the intensity value.

28. The device according to claim 21, wherein the control device (21) comprises a processor, which is configured to execute a computer-implemented method for reconstructing a multidimensional structure of a sample (P) from a multidimensional XCT measurement data set ( [symbol] (Kx, Ky, Kz)), comprising the steps:
reading, into a processor (21B), intensity values of a multidimensional XCT measurement data set (O(Kx, Ky, Kz)), wherein positions of the intensity values in the frequency space (Kx, Ky, Kz) are given by at least one lateral frequency space coordinate (Kx, Ky) and an axial frequency space coordinate (Kz); and
executing, with the processor (21B), a Fourier transformation algorithm, which transforms the multidimensional XCT measurement data set ( [symbol] (Kx, Ky, Kz)) into a sample structure data set ( [symbol] (x, y, z)), wherein the sample structure data set (O(x, y, z)) comprises, in a physical space (x, y, z), a depth direction coordinate (z) of the sample (P), which is assigned to the axial frequency space coordinate (Kz), and at least one lateral coordinate (x, y) of the sample (P), which is assigned to the at least one lateral frequency space coordinate (Kx, Ky).
